(19) United States
(12) Patent Application Publication
(10) Pub. No.: US 2026/0244131 A1
(43) Pub. Date: Aug. 20, 2026

(54) IMAGE FORMING APPARATUS

(71) Applicant: CANON KABUSHIKI KAISHA, Tokyo (JP)

(72) Inventors: YASUTOMO TANAKA, Chiba (JP); YOSHIHISA NOMURA, Kanagawa (JP); KOSUKE YASAKI, Ibaraki (JP); CHIAKI YOSHINO, Chiba (JP)

(21) Appl. No.: 19/530,532

(22) Filed: Feb. 5, 2026

(30) Foreign Application Priority Data
Feb. 20, 2025 (JP) 2025-026297

(51) Int. Cl. G03G 15/20; G03G 15/00

(52) U.S. Cl. CPC G03G 15/2039; G03G 15/5041

(57) ABSTRACT

An image forming apparatus includes a fixing portion for fixing an image onto a recording material by applying heat, a generating portion for generating an image data and an attribute data indicating an attribute of the image data and indicating whether or not the image data includes a character. A compressing portion compresses the image data and generates a compressed image data, and compresses the attribute data and generates a compressed attribute data. A setting portion analyzes the compressed attribute data corresponding to the image for one page, which is to be formed on one sheet of the recording material, in a state of being compressed, and sets a target temperature of the fixing portion at a time when the image of one page is fixed based on an analyzing result. A controller controls the fixing portion based on the target temperature set by the setting portion.

### BACKGROUND

### Field of the Technology

The present invention relates to an image forming apparatus provided with a fixing device which fixes a toner image onto a recording material.

### Description of the Related Art

In an image forming apparatus provided with a fixing device which fixes a toner image formed through an electrophotographic type onto a recording material, it is often a case that, in advance, depending on a toner amount per unit area applied onto the recording material, a temperature of the fixing device (fixing temperature) is determined. Usually, a maximum value for the toner amount per unit area is determined in advance, and so that the fixing temperature becomes a temperature capable of reliably fixing an image, in which the toner amount is the maximum value, onto the recording material, temperature adjustment is performed.

On the other hand, depending on an image to be output, there is a case in which the toner amount falls significantly below the maximum value for the toner amount which can be assumed, and in the case of outputting such an image, excessive heating is performed and waste occurs in power consumption. To this, in Japanese Patent Application Laid-Open No. 2022-130158, a technology which intends reduction in the power consumption by adjusting the fixing temperature depending on image data to be printed is disclosed.

Generally, in a case in which the toner exists at a high density, much heat is taken from a fixing member during fixing. In addition, in a case of a text image, since the toner is applied in line units, the heat of the fixing member is less likely to be taken during fixing. Based on such characteristics, based on a density of the toner and an image type, the fixing temperature may be determined. In this case, it is necessary to analyze density information and the image type of the image data of an entire page to be printed.

### SUMMARY

According to an aspect of the present invention, there is provided an image forming apparatus comprising: an image forming portion configured to form an image on a recording material with toner based on an image data; a fixing portion configured to fix the image onto the recording material by applying heat on the recording material on which the image is formed by the image forming portion; a generating portion configured to generate the image data and generate an attribute data indicating an attribute of the image data and indicating whether or not the image data includes at least a character; a compressing portion configured to compress the image data and generate a compressed image data, and configured to compress the attribute data and generate a compressed attribute data; a setting portion configured to analyze the compressed attribute data corresponding to the image for one page, which is to be formed on one sheet of the recording material, in a state of being compressed, and configured to set a target temperature of the fixing portion at a time when the image for the one page is fixed onto the recording material based on an analyzing result; and a controller configured to control the fixing portion based on the target temperature set by the setting portion.

Further features of the present invention will become apparent from the following description of exemplary embodiments with reference to the attached drawings.

### BRIEF DESCRIPTION OF THE DRAWINGS

FIG. 1 is a block diagram illustrating an outline configuration of an image forming apparatus.

FIG. 2 is a schematic cross-sectional view of a printer portion.

FIG. 3 is a block diagram of a controller portion.

FIG. 4 is a block diagram of a system control portion and a printer control portion.

FIG. 5 is a schematic diagram illustrating a configuration of packet data.

FIG. 6 is a schematic view illustrating tile image data.

FIG. 7, part (a), part (b), and part (c), includes block diagrams of each image processing portion (print processing portion, loopback processing portion, scan processing portion).

FIG. 8, part (a), part (b), and part (c), includes explanatory views of an example of a format of attribute data.

FIG. 9, part (a) and part (b), includes explanatory views of packbits compression.

FIG. 10, part (a) and part (b), includes flowchart diagrams of fixing temperature control.

FIG. 11 is a flowchart diagram of fixing temperature determining process.

FIG. 12 is a flowchart diagram of attribute information analyzing process.

### DESCRIPTION OF THE EMBODIMENTS

Hereinafter, an image forming apparatus according to the present invention will be described in more detail with reference to the drawings.

### Embodiment 1

### <Outline Configuration of the Image Forming Apparatus>

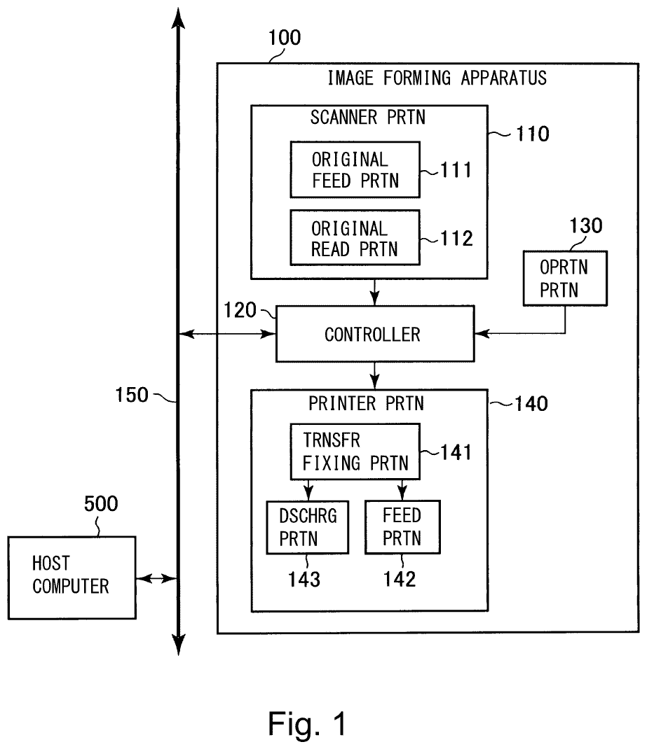

FIG. 1 is a block diagram illustrating an outline configuration of an image forming apparatus 100 in the present Embodiment. Incidentally, a recording material is also referred to as a paper, however, the recording material is not limited to being composed of paper, but includes those composed of material other than paper such as a plastic sheet and a synthetic paper or material containing the material other than paper. In addition, the image forming apparatus 100 may be, for example, a copying machine, a printer, a facsimile device, a multifunction machine provided with a plurality of functions among these functions, a printing machine, etc.

A scanner portion 110 optically reads an image of an original, and converts the read image into image data. The scanner portion 110 is configured to include an original reading portion 112 and an original feeding portion 111. The original reading portion 112 has a function to read the original. The original feeding portion 111 has a function to convey the original.

A printer portion 140 conveys the recording material (transfer material, sheet) having a sheet shape such as a paper, prints the image data as a visible image onto the recording material, and discharges the recording material to an outside of the image forming apparatus 100. The printer portion 140 is configured to include a sheet feeding portion 142, a transferring and fixing portion 141, and a sheet discharging portion 143. The sheet feeding portion 142 includes a plurality of types of sheet feeding cassettes. The transferring and fixing portion 141 has a function to transfer the image data onto the recording material as the visible image, and to fix the transferred visible image onto the recording material. The sheet discharging portion 143 has a function to output the printed recording material to the outside of the apparatus. The sheet discharging portion 143 may have a function to perform post processing such as sorting and stapling to the printed recording material, and then output the recording material to the outside of the apparatus.

A controller portion 120 is electrically connected to the scanner portion 110 and the printer portion 140, and is connected to a network 150 such as a LAN, a public line, and the Internet/an intranet. The controller portion 120 controls the scanner portion 110 to read the image data of the original, and controls the printer portion 140 to provide a function (copy function) to output the image data to the recording material as the visible image. In addition, the controller portion 120 provides a function (scanner function) to convert the image data read from the scanner portion 110 into code data, and to send the code data to a host computer 500, which is an example of an external device, etc., via the network 150. In addition, the controller portion 120 provides a function (printer function) to convert the code data received from the host computer 500 via the network 150 into the image data, and output the image data to the printer portion 140. Further, the controller portion 120 provides a function (FAX receiving function) to receive data from the public line and print the data, and a function (FAX sending function) to send scanned data to the public line. These processes such as scanning, printing and FAX sending/receiving are referred to as a “job”. The controller portion 120 controls and processes the job in accordance with an instruction. The jobs may be simultaneously processed in parallel depending on a combination.

An operating portion 130 is connected to the controller portion 120. In the present Embodiment, the operating portion 130 is constituted by a liquid crystal touch panel having a function of an input portion and a function of a display portion. The operating portion 130 provides a user interface for a use to operate the image forming apparatus 100.

### <Configuration of the Printer Portion and Image Forming Operation>

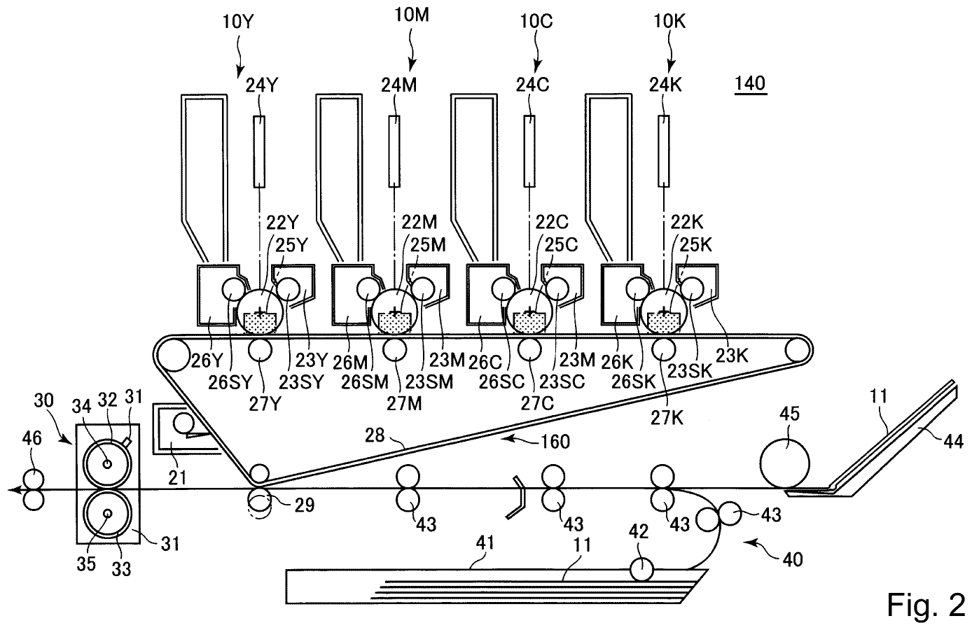

FIG. 2 is a schematic cross-sectional view of the printer portion 140 constituting the image forming apparatus 100 in the present Embodiment. In the present Embodiment, the printer portion 140 is capable of forming a full-color image using an electrophotographic type, and employs an intermediary transfer type and a tandem type.

The printer portion 140 includes four image forming units (stations) 10Y, 10M, 10C, and 10K, which form images of respective colors of yellow (Y), magenta (M), cyan (C), and black (K), respectively. Elements having the same or corresponding functions or configurations provided for the respective colors may be collectively described by omitting Y, M, C, and K at the end of reference numerals, which indicate that the elements are for any of the colors. In the present Embodiment, the image forming unit 10 is configured to include a photosensitive member 22, a charger 23, an exposure device 24, a developing device 26, etc.

The photosensitive member (photosensitive drum) 22 as an image bearing member is rotated by driving force from a driving motor 25 as a driving means being transmitted. The driving motor 25 causes the photosensitive member 22 to be rotated in a counterclockwise direction in FIG. 2 in accordance with an image forming operation. A surface of the rotating photosensitive member 22 is uniformly charged by the charger (injection charger) 23 as a charging means. To the charger 23, a charging sleeve 23S, which is rotated with carrying magnetic particles and is in contact with the surface of the photosensitive member 22, is provided. The charged surface of the photosensitive member 22 is selectively exposed by laser light emitted in accordance with image information by the exposure device (laser scanner) 24 as an exposure means, and an electrostatic latent image (electrostatic image) is formed on the photosensitive member 22. The electrostatic latent image formed on the photosensitive member 22 is developed (visualized) by toner being supplied by the developing device 26 as a developing means, and a toner image (developer image) is formed on the photosensitive member 22. To the developing device 26, a developing sleeve 26S, which is rotated with carrying a two-component developer provided with the toner (non-magnetic toner particle) as a developer and a carrier (magnetic carrier particle), is provided. In addition, in the present Embodiment, each developing device 26 is mountable to and dismountable from an apparatus main assembly of the image forming apparatus 100.

So as to be opposite to the four photosensitive members 22, an intermediary transfer belt 28 constituted by an endless belt as an intermediary transfer member is disposed. The intermediary transfer belt 28 is stretched by a plurality of stretching rollers. The intermediary transfer belt 28 is rotated (circulated) in a clockwise direction in FIG. 2 by driving force from a driving motor (not shown) as a driving means being transmitted to a driving roller, which is one of the plurality of stretching rollers. On an inner peripheral surface side of the intermediary transfer belt 28, at positions opposite to the respective photosensitive members 22Y, 22M, 22C, and 22K, primary transfer rollers 27Y, 27M, 27C, and 27K as primary transfer means are disposed. The primary transfer roller 27 is pressed toward the photosensitive member 22, and forms a primary transfer portion, in which the photosensitive member 22 and the intermediary transfer belt 28 are in contact with each other. The toner image formed on the photosensitive member 22 is transferred (primarily transferred), in the primary transfer portion, onto the rotating intermediary transfer belt 28. During primary transfer, to the primary transfer roller 27, a predetermined primary transfer bias (primary transfer voltage) is applied. Incidentally, by providing a difference between a rotation speed of the photosensitive member 22 and a rotation speed of the intermediary transfer belt 28, the toner image can be efficiently transferred onto the intermediary transfer belt 28. For example, during formation of the full-color image, the toner images of the respective colors of yellow, magenta, cyan, and black formed on the respective photosensitive members 22 are sequentially transferred onto the intermediary transfer belt 28 so as to be superimposed. The toner remaining on the photosensitive member 22 during primary transfer (primary transfer residual toner) is collected by the developing device 26. A cleaning device which removes and collects the primary transfer residual toner from the photosensitive member 22 may be provided.

On an outer peripheral surface side of the intermediary transfer belt 28, at a position opposite to a secondary transfer opposite roller, which is one of the plurality of stretching rollers, a secondary transfer roller 29 as a secondary transfer means is disposed. The secondary transfer roller 29 is pressed toward the secondary transfer opposite roller, and forms a secondary transfer portion in which the intermediary transfer belt 28 and the secondary transfer roller 29 are in contact with each other. The toner image formed on the intermediary transfer belt 28 is transferred (secondarily transferred), in the secondary transfer portion, onto a recording material 11, which is nipped and conveyed by the intermediary transfer belt 28 and the secondary transfer roller 29. During secondary transfer, to the secondary transfer roller 29, a predetermined secondary transfer bias (secondary transfer voltage) is applied. The toner remaining on the intermediary transfer belt 28 during secondary transfer is removed and collected from the intermediary transfer belt 28 by a belt cleaning device 21 as an intermediary transfer member cleaning means.

The recording material 11 is accommodated in a sheet feeding tray 41. The recording material 11 accommodated in the sheet feeding tray 41 is sent out from the sheet feeding tray 41 by a sheet feeding roller 42, and is conveyed to the secondary transfer portion by conveyance rollers 43, etc. Alternatively, the recording material 11 is stacked on a manual feed tray 44. The recording material 11 stacked on the manual feed tray 44 is sent out from the manual feed tray 44 by a manual feed sheet feeding roller 45, and is conveyed to the secondary transfer portion by the conveyance rollers 43, etc. In the present Embodiment, the sheet feeding portion 142 (FIG. 1) is constituted by the sheet feeding tray 41, the sheet feeding roller 42, the manual feed tray 44, the manual feed sheet feeding roller 45, etc. Incidentally, the secondary transfer roller 29 is disposed, while transferring the toner image onto the recording material 11, at a position in contact with the intermediary transfer belt 28 via the recording material 11 as shown by a solid line in FIG. 2, and after a print process, is disposed at a position separated from the intermediary transfer belt 28 as shown by a dashed double-dotted line.

The recording material 11, onto which the toner image has been transferred, is conveyed to a fixing device 30 as a fixing means (fixing portion). The fixing device 30 includes a fixing roller (heating roller) 32 as a rotatable heating member which heats the recording material 11, and a pressing roller 33 as a rotatable pressing member which is brought into a pressure contact with the fixing roller 32. The pressing roller 33 brings the recording material 11 into the pressure contact with the fixing roller 32. The fixing roller 32 and the pressing roller 33 are constituted by hollow rollers, respectively. Inside hollow portions of the fixing roller 32 and the pressing roller 33, heaters 34 and 35 are disposed, respectively. The fixing device 30 nips and conveys the recording material 11, which holds the unfixed toner image, with the fixing roller 32 and the pressing roller 33. As a result, the fixing device 30 applies heat and pressure to the recording material 11, which holds the unfixed toner image, and fixes (melts, sticks) the toner image onto the recording material 11. In addition, to the fixing device 30, a temperature sensor 31 as a detecting means for detecting a temperature of the fixing device 30, e.g., a temperature of the fixing roller 32 is provided. The temperature sensor 31 is constituted by a thermistor, etc. The controller portion 120 controls, based on a detection result of the temperature by the temperature sensor 31, by controlling electric power supplied to the heaters 34 and 35, the temperature of the fixing device 30 (fixing temperature). The fixing temperature is represented by, for example, the temperature of the fixing roller 32. The controller portion 120 controls so as to perform a fixing operation, based on the detection result of the temperature sensor 31, only when a sufficient temperature for the fixing is confirmed. For example, the controller portion 120 (in more detail, a fixing temperature control portion 319 of a printer control portion 280, which will be described below) causes, based on the detection result of the temperature by the temperature sensor 31, the electric power supplied to the heaters 34 and 35 to be turned on/off. By this, the controller portion 120 controls the fixing device 30 so that the fixing temperature becomes a target temperature (becomes equal to or higher than the target temperature). For example, in a case in which the detected temperature is lower than the target temperature, the controller portion 120 outputs a control signal causing the heaters 34 and 35 to be turned on. In addition, in a case in which the detected temperature is higher than a set temperature, the controller 120 outputs the control signal causing the heaters 34 and 35 to be turned off.

The recording material 11, to which the toner image has been fixed, is thereafter discharged (output) to a discharge tray (not shown) by a discharging roller 46, etc. In the present Embodiment, the sheet discharging portion 143 (FIG. 1) is constituted by the discharging roller 46, etc. With the above, the image forming operation ends.

In the present Embodiment, the transferring and fixing portion 141 (FIG. 1) is constituted by each image forming unit 10, the intermediary transfer belt 28, each primary transfer roller 27, the secondary transfer roller 29, the fixing device 30, etc. In addition, in the present Embodiment, an image forming portion 160, which forms the toner image on the recording material 11, is constituted by each image forming unit 10, the intermediary transfer belt 28, each primary transfer roller 27, the secondary transfer roller 29, etc.

### <Controller Portion>

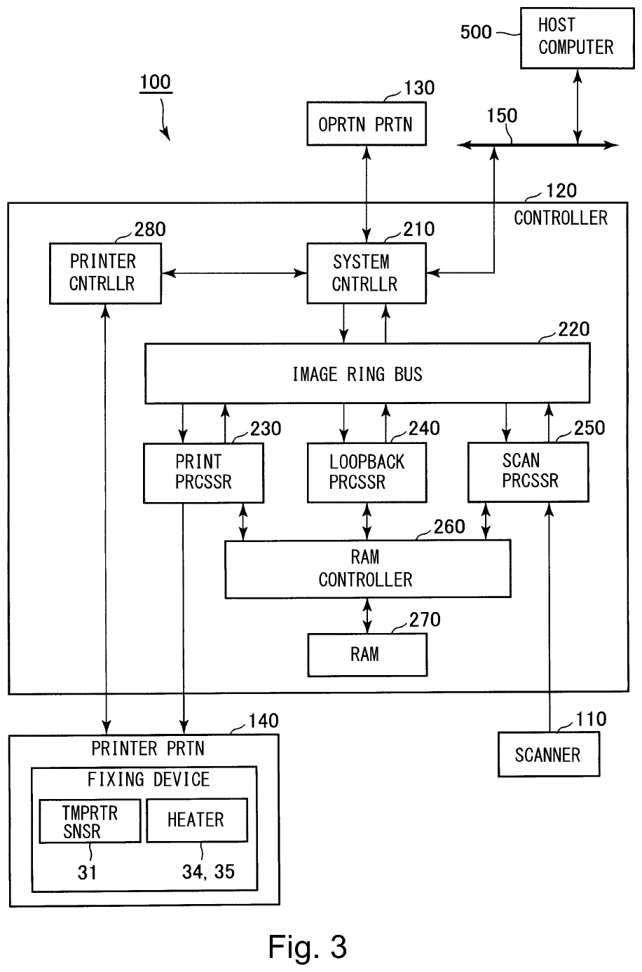

FIG. 3 is a block diagram of the controller portion 120 in the present Embodiment.

The controller portion 120 includes a system control portion 210, the printer control portion 280, an image ring bus 220, a print processing portion 230, a loopback processing portion 240, a scan processing portion 250, a RAM controller 260, and a RAM 270.

The system control portion 210 includes a CPU therein, and controls scan process using the scanner portion 110 and print process using the printer portion 140 of the image forming apparatus 100. In addition, the system control portion 210 performs transfer of the image data for performing these process via the image ring bus 220. Further, the system control portion 210 performs data sending to the network 150, data receiving from the network 150, display process to the operating portion 130, etc. In this manner, the system control portion 210 comprehensively controls a whole system.

The printer control portion 280 includes a CPU therein, and performs control of the printer portion 140 in cooperation with the system control portion 210. Specifically, the printer control portion 280 performs control of the temperature of the fixing device 30 (fixing temperature), which constitute the transferring and fixing portion 141, etc.

The image ring bus 220 is a bus for transferring the image data to each block such as the system control portion 210, the print processing portion 230, the loopback processing portion 240, and the scan processing portion 250 inside the controller portion 120. In the present Embodiment, a data line for transferring the image data to these respective portions are connected in a ring shape via the image ring bus 220. As a result, the system control portion 210, and the print processing portion 230, the loopback processing portion 240, and the scan processing portion 250 can exchange the image data with each other.

The print processing portion 230 performs various types of image processing such as color space conversion processing, halftone processing, and gamma correction for printing the image data with the printer portion 140. The print processing portion 230 receives the image data from the image ring bus 220, performs these image processing to the image data, and then outputs the image data to the printer portion 140.

The loopback processing portion 240 is a block which executes image processing which may be used in both the print processing and the scan processing. The loopback processing portion 240 receives the image data from the system control portion 210 via the image ring bus 220, performs the image processing internally, and then returns the image data back to the system control portion 210 via the image ring bus 220.

The scan processing portion 250 performs image processing such as shading correction processing, MTF correction processing, input gamma correction, and filter processing to the image data read by the scanner portion 110. The scan processing portion 250 transfers, after performing these image processing to the image data transferred from the scanner portion 110, the image data to the image ring bus 220. The image data transferred to the image ring bus 220 is transferred to the system control portion 210 via the image ring bus 220.

The RAM controller 260 receives the image data from each of the print processing portion 230, the loopback processing portion 240, and the scan processing portion 250, and performs control for temporarily writing the image data into the RAM 270. In addition, the RAM controller 260 reads, in accordance with an instruction from each of these portions, the image data written into the RAM 270, and performs a process for transferring the image data to each of these portions. The print processing portion 230, the loopback processing portion 240, and the scan processing portion 250 each utilize, in order to execute the image processing internally and/or in order to sort the image data, the RAM 270 as a temporary image buffer. In addition, through a transfer path between the RAM controller 260 and the RAM 270, respective image data of the print processing portion 230, the loopback processing portion 240, and the scan processing portion 250 are multiplexed and pass back and forth.

### <System Control Portion>

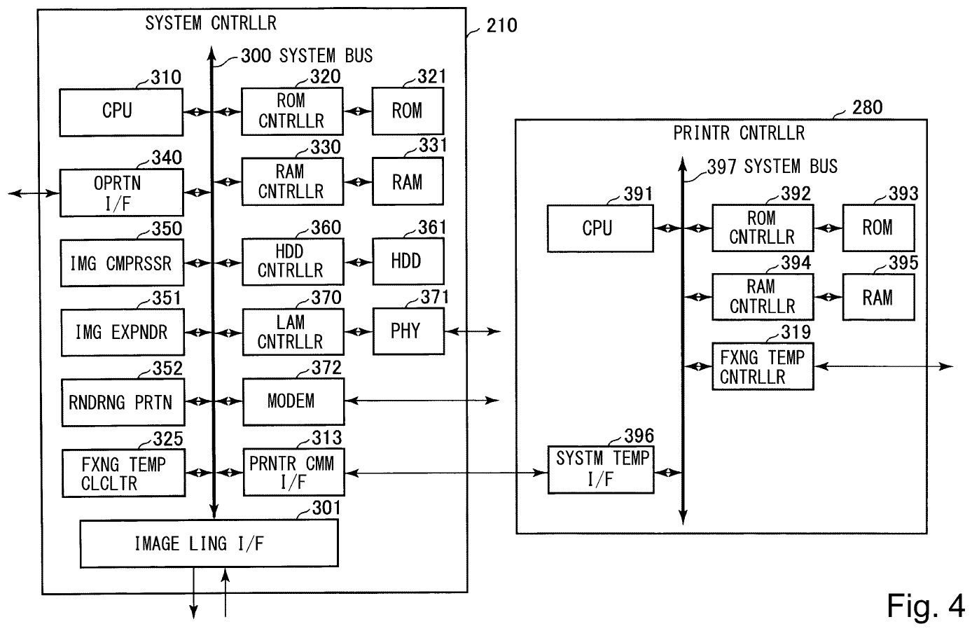

FIG. 4 is a block diagram of the system control portion 210 and the printer control portion 280 in the present Embodiment. First, blocks inside the system control portion 210 will be described.

The system control portion 210 includes a CPU 310, a ROM controller 320, a ROM 321, a RAM controller 330, a RAM 331, an operating portion interface 340, an HDD controller 360, an HDD 361, a LAN controller 370, a PHY 371, a modem 372, an image compressing portion 350, an image expanding portion 351, a rendering portion 352, a fixing temperature calculating portion 325, a printer communication I/F portion 313, and an image ring interface 301. Each block constituting the inside of the system control portion 210 is connected by a system bus 300.

The CPU 310 is a processor which controls a whole system. The CPU 310 comprehensively controls the processes related to the job such as the print process and the scan process in accordance with an OS (Operating System) and/or a control program expanded in the RAM 331.

The ROM controller 320 is a control module for accessing the ROM 321, which stores a boot program of the system. When a power source of the image forming apparatus 100 is turned on, the CPU 310 accesses the ROM 321 via the ROM controller 320, and executes the boot program.

The RAM controller 330 is a control module for accessing the RAM 331, in which the control program of the system and the image data are stored. The RAM controller 330 is provided with a register for performing setting and control of the RAM 331, and this register is accessible from the CPU 310.

The operating portion interface 340 performs control for receiving of an operation instruction and displaying of an operation result upon a user operating the operating portion 130.

The HDD 361 is a hard disk drive, and stores system software, an application program, the image data, page information and job information corresponding to each image data. The HDD 361 is connected to the system bus 300 via the HDD controller 360, and performs reading out and writing in of data in accordance with an instruction from the CPU 310.

The LAN controller 370 is connected to the network 150 via the PHY 371, and performs input/output of information such as the image data with the external device such as the host computer 500.

The modem 372 is connected to the public line (not shown), and performs data communication with an external FAX device upon performing a FAX sending job and a FAX receiving job.

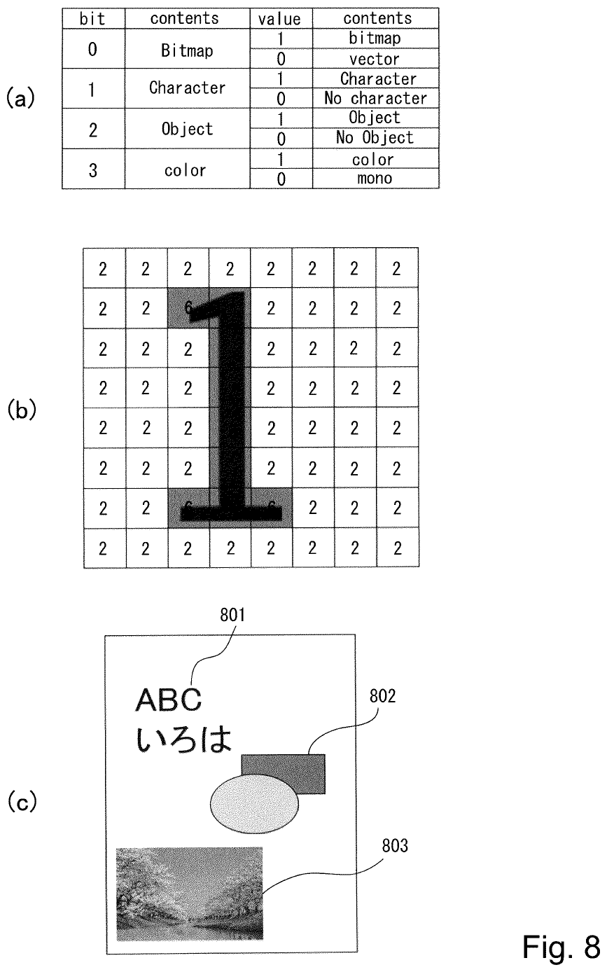

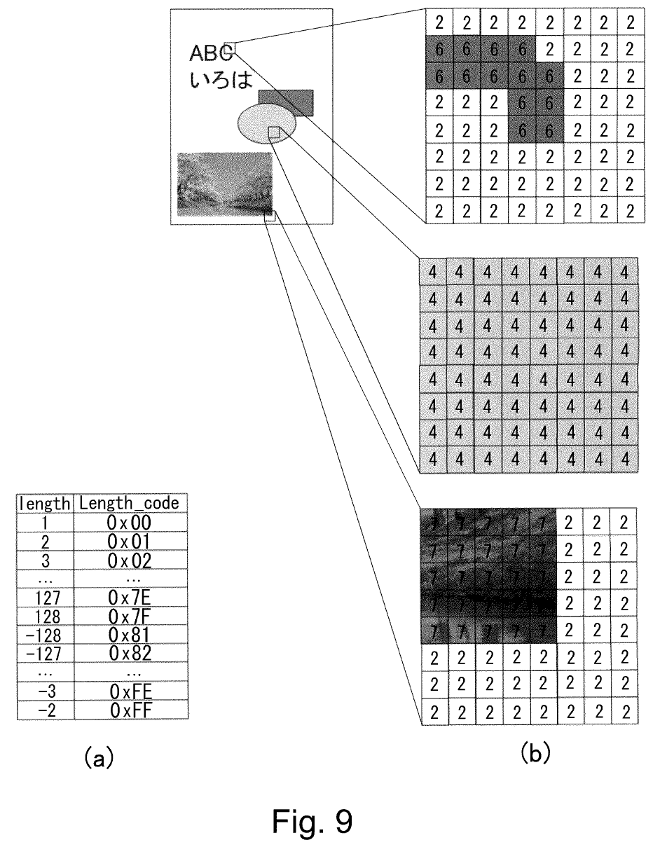

The image compressing portion 350 processes the image data stored in the RAM 331 or the HDD 361 to be compressed into JPEG format. In addition, the image compressing portion 350 applies compression processing to attribute data, which is image additional information stored in the RAM 331 or the HDD 361, with a packbits compression method. The image compressing portion 350 constitutes a compressing portion which compresses the image data and generates compressed image data, and compresses the attribute data and generates compressed attribute data. Compression refers to representing digital data with a smaller amount of information by utilizing redundancy and regularity included in the digital data. In the present Embodiment, through the compression of the attribute data, roughly, in a case in which the same character continues, by recording the character and a number of repetitions, reversibly, the attribute data is represented by a smaller amount of information. The attribute data and the packbits compression method will be described below using FIG. 8 and FIG. 9.

The image expanding portion 351 performs expansion processing of the image data compressed in the JPEG format (herein, also referred to as “compressed image data”) and the attribute data compressed into packbits (herein, also referred to as “compressed attribute data”).

The rendering portion 352 expands the image data (PDL (Page Description Language) code), which is received from the external device such as the host computer 500 via the LAN controller 370 from the network 150, into bitmap data (bitmap image data), which is image data, (in other words, generates the image data). At the same time, the rendering portion 352 generates the attribute data, which will be described below, based on the PDL code. The rendering portion 352 constitutes a generating portion which generates the image data and generates the attribute data indicating an attribute of the image data and indicating whether or not the image date includes at least a character. The bitmap data (image data) and the attribute data are converted into a packet data format, which will be described below, and then subjected to the compression processing by the image compressing portion 350, and stored in the RAM 331 or the HDD 361. The bitmap data and the attribute data are used in a printing function. In addition, by the image compressing portion 350, the bitmap data is compressed into JPEG and the attribute data is compressed into packbits, and by the fixing temperature calculating portion 325, which will be described below, is used for analysis in the state of being compressed.

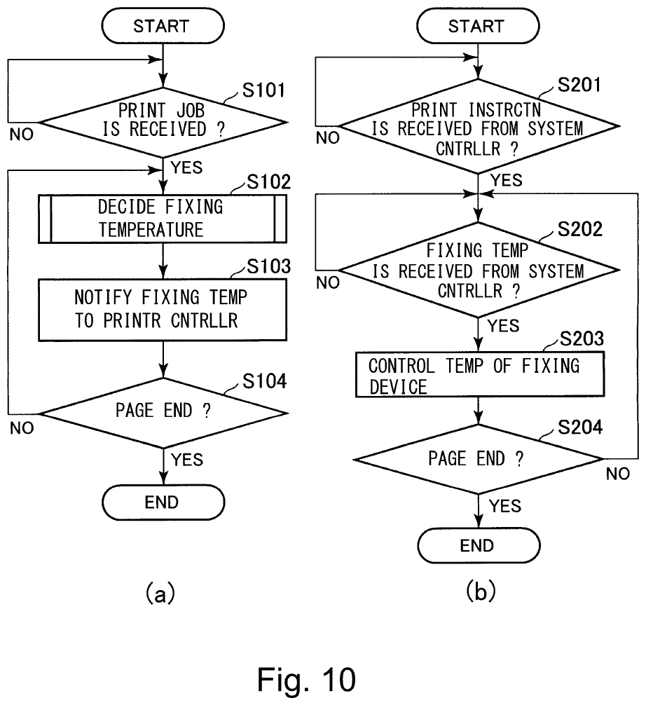

The fixing temperature calculating portion 325 calculates the target temperature for the fixing temperature (hereinafter, also referred to as a “fixing target temperature”) required for printing a page to be printed. This is performed by analyzing the attribute data described above in the state of being compressed. By this, the fixing temperature calculating portion 325 calculates an appropriate fixing target temperature in accordance with the image data. The fixing temperature calculating portion 325 constitutes a setting portion which analyzes the compressed attribute data corresponding to an image for one page, which is to be formed on one sheet of the recording material, in the state of being compressed, and sets the target temperature of the fixing portion (fixing device) 30 at a time when the image for the one page is fixed to the recording material based on an analyzing result. Details of an operation of the fixing temperature calculating portion 325 will be described below using flowchart diagrams in FIG. 10 through FIG. 12.

The printer communication I/F portion 313 is an I/F portion (interface portion) for performing communication between the system control portion 210 and the printer control portion 280. Information communicated via the printer communication I/F portion 313 includes a control signal from the system control portion 210, fixing target temperature information required for printing each page calculated by the fixing temperature calculating portion 325, etc.

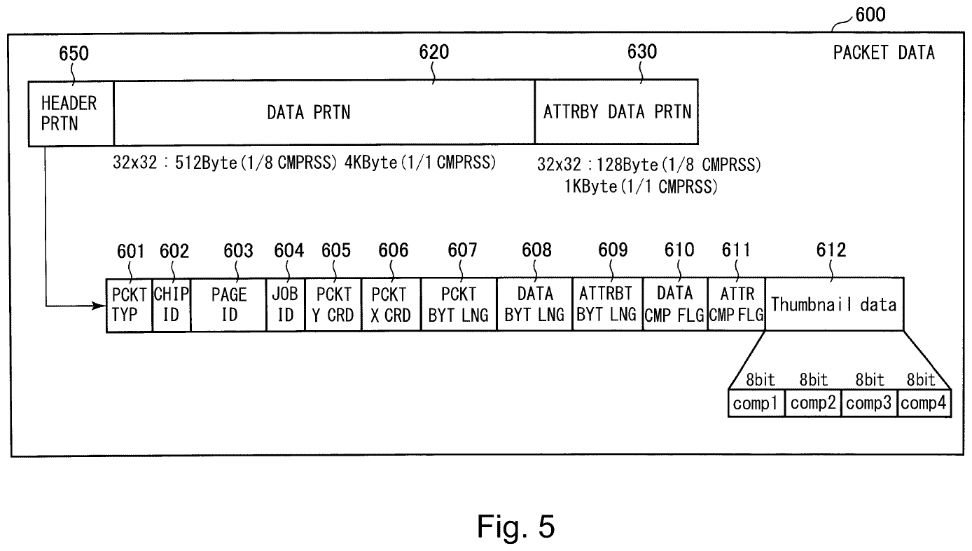

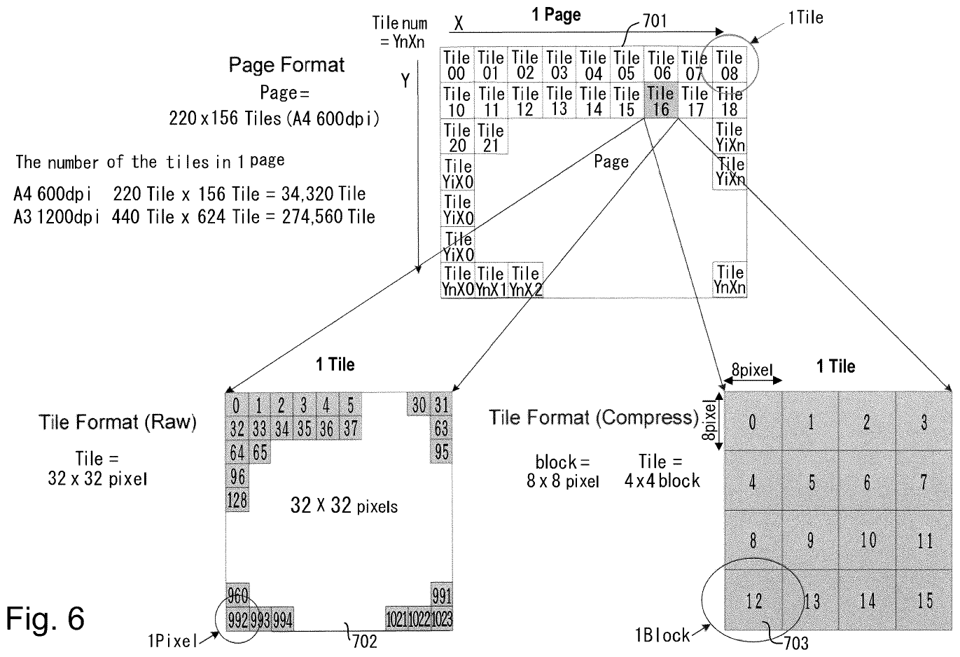

The image ring interface 301 is an interface block which connects the system bus 300 inside the system control portion 210 and each image processing block (the print processing portion 230, the loopback processing portion 240, the scan processing portion 250) outside the system control portion 210 with the image ring bus 220. Data flowing through the image ring bus 220 is referred to as “packet data” or simply as a “packet”. The image ring interface 301 sends the packet data stored in the RAM 331 or the HDD 361 to the image ring bus 220. In addition, the image ring interface 301 stores the packet data received from the image ring bus 220 in the RAM 331 or the HDD 361. Details of the packet data will be described below using FIG. 5 and FIG. 6.

### <Printer Control Portion>

Next, blocks inside the printer control portion 280 will be described.

The printer control portion 280 includes a CPU 391, a ROM controller 392, a ROM 393, a RAM controller 394, a RAM 395, the fixing temperature control portion 319, and a system communication I/F portion 396. Each block constituting the inside of the printer control portion 280 is connected by a system bus 395.

The CPU 391, the ROM controller 392, the ROM 393, the RAM controller 394, and the RAM 395 have functions similar to those described for the system control portion 210, and these are used for control of the printer portion 140.

The fixing temperature control portion 319 performs temperature control of the fixing device 30 based on the fixing target temperature determined by the fixing temperature calculating portion 325. The fixing temperature control portion 319 constitutes a control portion which controls the fixing portion (fixing device) 30 based on the target temperature set by the setting portion (fixing temperature calculating portion) 325.

The system communication I/F portion 396 is an I/F portion (interface portion) for performing the communication between the system control portion 210 and the printer control portion 280. The system communication I/F portion 396 is an I/F portion corresponding to the printer communication I/F portion 313. Information communicated via the system communication I/F portion 396 includes the control signal from the system control portion 210, the fixing temperature information required for printing each page calculated by the fixing temperature calculating portion 325, etc.

### <Packet Data Format>

Next, the packet data dealt in the image forming apparatus 100 in the present Embodiment will be described.

FIG. 5 is a schematic diagram illustrating an example of the packet data flowing through the image ring bus 220 in the present Embodiment. Packet data 600 is largely divided into a header portion 650, a data portion 620, and an attribute data portion 630. In addition, the header portion 650 is further divided into information shown by 601 through 612 in FIG. 5.

A packet type 601 indicates whether the packet data is the image data or a command. In a case in which the packet type 601 indicates that the packet data is the image data, the image data is stored in the data portion 620, and the attribute data is stored in the attribute data portion 630. In addition, in a case in which the packet type 601 indicates that the packet data is the command, in the data portion 620, a setting address and data indicating setting values for setting a coefficient, a mode, etc. for each image processing portion (the print processing portion 230, the loopback processing portion 240, and the scan processing portion 250) are stored.

A chip ID 602 indicates an ID (identifier) for identifying a process portion, which is to be a target to which the packet data is sent. For example, if the chip ID 602 is 0, it indicates that the target is the print processing portion 230, if the chip ID 602 is 1, it indicates that the target is the loopback processing portion 240, and if the chip ID 602 is 2, it indicates that the target is the scan processing portion 250.

A page ID 603 indicates a page number to which the packet data belongs. Processes such as the scanning and the printing may be executed for a plurality of pages, so that the page ID 603 indicates which page number the packet data belongs to in that case.

A job ID 604 indicates a job number to which the packet data belongs. For example, in a case in which a scan job and a print job are executed simultaneously, a job number 1 is set to the packet data for the scan job, and a job number 2 is set to the packet data for the print job, so that the job can be identified.

A packet Y coordinate 605 indicates, in the case in which the image data is stored in the data portion 620, at which Y coordinate (coordinate in a sub scanning direction) in a page the image data is positioned.

A packet X coordinate 606 indicates, in the case in which the image data is stored in the data portion 620, at which X coordinate (coordinate in a main scanning direction) in the page the image data is positioned.

In the present Embodiment, the image data stored in the data portion 620 is data obtained by dividing the image data of a page unit into rectangles of a size of a predetermined number of pixels (for example, 32 pixels×32 pixels). Therefore, in a case of regenerating page data from the packet data, the coordinate data described above are referred to. Incidentally, this image data is compressed by the image compressing portion 350 or a compressor (which will be described below) installed inside each image processing portion, and is stored in the data portion 620 as the compressed image data.

A packet byte length 607 indicates a total number of bytes of the packet data.

A data byte length 608 indicates a total number of bytes of the data portion 620 in the packet data.

An attribute byte length 609 indicates a total number of bytes of the attribute data portion 630 in the packet data.

For example, the data byte length becomes 4096 bytes, in a case in which one pixel is 4 bytes and a compression ratio is 1/1, with 32 pixels×32 pixels×4 bytes, and the data byte length becomes 512 bytes in a case in which the compression ratio is 1/8. Similarly, the attribute byte length becomes 1024 bytes, in a case in which one pixel is 1 byte and the compression ratio is 1/1, with 32 pixels×32 pixels×1 byte, and the attribute byte length becomes 128 bytes in a case in which the compression ratio is 1/8.

A data compression flag 610 is a flag indicating whether or not the data portion 620 is compressed. Incidentally, the data compression flag 610 may indicate, in a case of being compressed, by what compression type the data portion 620 is compressed. In the present Embodiment, assuming that the data portion 620 is compressed into JPEG.

An attribute compression flag 611 is a flag indicating whether or not the attribute data portion 630 is compressed. The attribute compression flag 611 may indicate, in a case of being compressed, by what compression type the attribute data portion is compressed. In the present Embodiment, assuming that the attribute data portion 630 is compressed into the packbits, which will be described below.

In other words, in the present Embodiment, for each of areas obtained by dividing the image for the one page to be formed on one sheet of the recording material (in more detail, a whole area of an image formable area in which the toner image can be formed) into plural areas, the image data and the attribute data are generated, and a plurality of the packets including the image data and the attribute data for each of the areas which are divided are generated. In the present Embodiment, for each of the areas obtained by dividing the image for the one page into the plural areas per the predetermined number of pixels, the image data and the attribute data are generated, and a plurality of the packets including the image data and the attribute data for each of the areas which are divided are generated. In addition, in the present Embodiment, the image data and the attribute data are compressed for each packet.

A Thumbnail data 612 stores thumbnail data. In the present Embodiment, it is assumed that, in the Thumbnail data 612, values (comp1 through comp4) obtained by averaging data for each color such as RGB and CMYK of each image data of 32 pixels×32 pixels of each packet are stored in 8 bits. By referring to the values in the Thumbnail data 612, it becomes possible to determine a rough density of the image for each packet. For example, in a case in which the packet is constituted by pixels of characters in a whole area and all colors in the Thumbnail data 612 are maximum density, it can be found that a character color is black.

Next, a format for the packet data will be described. FIG. 6 is a schematic view of tile image data in the present Embodiment.

In the present Embodiment, image data 701 for one page is dealt by dividing the image data 701 into image data 702 in units of a tile of 32 pixels×32 pixels. For example, a case in which an original of A4 size is read at a resolution of 600×600 dpi (dots per inch) by the scanner portion 110, and the image data 701 is divided into the tiles of 32×32 pixels is considered. In this case, 34320 pieces of the tile image data are generated from the original of A4 size. In the generation of a tile image, by adjusting settings depending on the reading resolution and convenience for the image processing, the tile image may be made into a shape and the number of pixels which are easy to be dealt.

It is not necessary for the unit of the tile to be 32×32 pixels, but may be, for example, 64×64 pixels. In addition, it is not necessary for the tile to be a square, but may be another rectangular shape such as a rectangle. Upon compressing the image data, data for one page is not compressed collectively, but only the image data is compressed for each tile (packet). As for a compression unit, compression may be performed for each block 703 obtained by further dividing the tile (packet) into 8×8 pixels, which is a unit for JPEG. On the other hand, in the present Embodiment, as for the attribute data, compression is performed by packbits compression, which will be described below using FIG. 8 and FIG. 9.

In the present Embodiment, through the image ring bus 220, the packet data as described above flows. And each image processing portion receives and interprets the packet data, and if it is the packet indicating the command, then each image processing portion sets the mode and the coefficient, etc. for the processing, and if it is the packet indicating the image data, then each image processing portion executes the image processing to the image data.

Incidentally, in the present Embodiment, performing sending/receiving of the packet data in which the image data, which is obtained by dividing the image for the one page per the predetermined number of pixels, and the attribute data, which is the additional information of the image data, are collected may be described as performing sending/receiving of the image data for convenience.

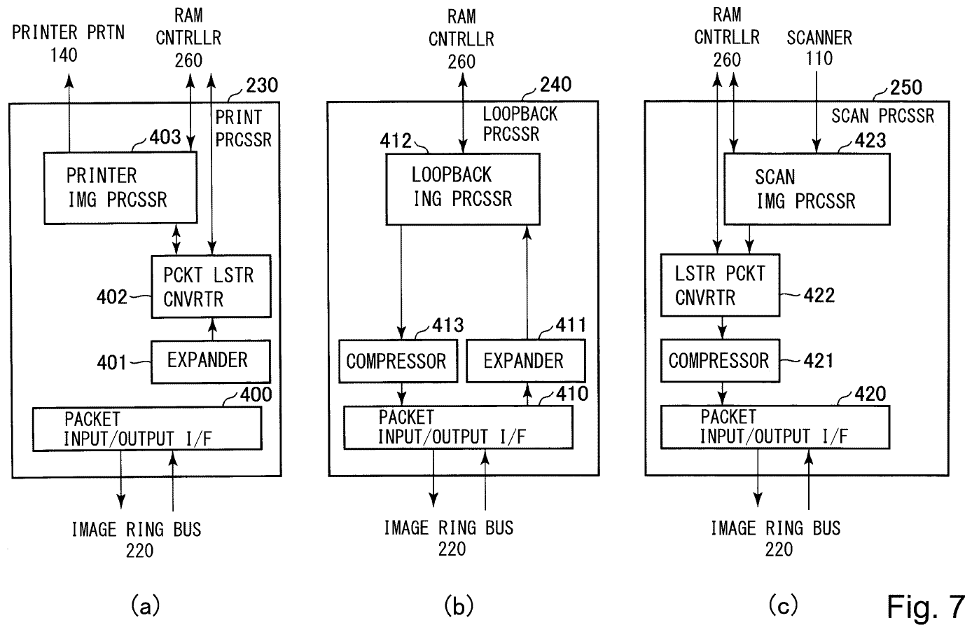

Next, using FIG. 7, each image processing portion (the print processing portion 230, the loopback processing portion 240, and the scan processing portion 250) will be described.

### <Print Processing Portion>

Part (a) of FIG. 7 is a block diagram illustrating an internal structure of the print processing portion 230.

Upon receiving the packet data, a packet input/output I/F 400 refers to the chip ID 6032 in the header portion 650, and checks whether or not the chip ID is the same as a chip ID assigned to itself (the print processing portion 230). In a case in which the chip ID indicated by the chip ID 602 is different from the chip ID assigned to itself, the packet input/output I/F 400 determines that it is not the packet data to be processed by the image processing portion of itself, and transfers the packet data to a next image processing portion. On the other hand, in a case in which the chip ID indicated by the chip ID 602 is the same as the chip ID assigned to itself, if the packet is the image data, the packet input/output I/F 400 executes the image processing through an internal image processing path (from an expander 401 to a printer image processing portion 403). In addition, if the packet is the command, the packet input/output I/F 400 refers to the setting address and the setting values stored in the data portion 620, and sets the coefficient and the mode for the designated image processing portion.

The expander 401 expands the compressed image data input from the packet input/output I/F 400, and restores the image data to a pixel state in which a subsequent image processing can be executed.

A packet raster converting portion 402 receives the expanded pixel data from the expander 401, and converts the pixel data into raster image data. As described above, in the present Embodiment, the image data in the packet is the rectangle of 32 pixels×32 pixels. In the image forming apparatus 100 of the electrophotographic type, the print process in the printer portion 140 is performed in a raster order (line sequential), so that the packet raster converting portion 402 converts the order of the pixels of the image data into the raster order. In addition, in the present Embodiment, the RAM 270 is used as a temporary buffer for converting the image data from the rectangle of 32 pixels×32 pixels into the raster order, so that the packet raster converting portion 402 accesses the RAM 270 via the RAM controller 260.

The printer image processing portion 403 receives the image data converted into the raster order from the packet raster converting portion 402, and performs the image processing as pre processing for printing the image data with the printer portion 140. Specifically, the image processing includes the color space conversion processing for converting RGB into CMYK, the halftone processing by a dither method or an error diffusion method, the gamma correction, etc. The image data after the image processing is output to the printer portion 140. In addition, the printer image processing portion 403 needs to output the image data to the printer portion 140 timed with turning on of the printer portion 140 and the feeding of the recording material 11 from the sheet feeding portion 142. Therefore, the printer image processing portion 403 temporarily writes the image data into the RAM 270 via the RAM controller 260 as a buffer for waiting until the timing. Then, the printer image processing portion 403 reads, so as to synchronize with the timing of the feeding of the recording material 11, the image data from the RAM 270, and outputs the image data to the printer portion 140.

### <Loopback Processing Portion>

Part (b) of FIG. 7 is a block diagram illustrating an internal structure of the loopback processing portion 240.

Upon receiving the packet data, a packet input/output I/F 410 refers to the chip ID 602 of the header portion 650, and checks whether or not the chip ID is the same as a chip ID assigned to itself (the loopback processing portion 240). In a case in which the chip ID indicated by the chip ID 603 is different from the chip ID assigned to itself, the packet input/output I/F 410 determines that it is not the packet data to be processed by the image processing portion of itself, and transfers the packet data to a next image processing portion. On the other hand, in a case in which the chip ID indicated by the chip ID 602 is the same as the chip ID assigned to itself, if the packet is the image data, then the packet input/output I/F 410 executes image processing through an internal image processing path (from an expander 411 to a loopback image processing portion 412). And upon receiving the image data after the image processing from a compressor 413, the packet input/output I/F 410 adds a header to the image data to format as the packet data, and sends the packet data to the system control portion 210. In addition, if the packet is the command, the packet input/output I/F 410 refers to the setting address and the setting values stored in the data portion 620, and sets the coefficient and the mode for the designated image processing portion.

The expander 411 expands the compressed image data input from the packet input/output I/F 410, and restores the image data to the pixel state in which a subsequent image processing can be executed.

The compressor 413 compresses the processed image data input from the loopback image processing portion 412, and outputs the compressed image data to the subsequent packet input/output I/F 410. The compression processing is performed to compress again the image data expanded by the expander 411.

The loopback image processing portion 412 receives the image data from the expander 411, and performs the image processing set to be performed in the loopback processing portion 240. This function can be used both in the print processing and the scan processing.

### <Scan Processing Portion>

Part (c) of FIG. 7 is a block diagram illustrating an internal structure of the scan processing portion 250.

Upon receiving the packet data, a packet input/output I/F 420 refers to the chip ID 602 of the header portion 650, and checks whether or not the chip ID is the same as a chip ID assigned to itself (the scan processing portion 250). In a case in which the chip ID indicated by the chip ID 603 is different from the chip ID assigned to itself, the packet input/output I/F 420 determines that it is not the packet data to be processed by the image processing portion of itself, and transfers the packet data to the next image processing portion. On the other hand, in a case in which the chip ID indicated by the chip ID 6032is the same as the chip ID assigned to itself, if the packet is the command, the packet input/output I/F 420 refers to the setting address and the setting values stored in the data portion 620, and sets the coefficient and the mode for the designated image processing portion. Incidentally, since the image data is input to the scan processing portion 250 only from the scanner portion 110, the packets received in the packet input/output I/F 420 are only the command.

A compressor 421 compresses the image data input from a raster packet converting portion 422, and outputs the compressed image data to the subsequent packet input/output I/F 420. The compression processing is performed to compress the image data in the packet data sent by the packet input/output I/F 420.

The raster packet converting portion 422 converts the pixel data input from a scan image processing portion 423 into the image data of the rectangle of 32 pixels×32 pixels. As described above, in the present Embodiment, the image data in the packet is the rectangle of 32 pixels×32 pixels. Therefore, the raster packet converting portion 422 converts the pixel data input from the scan image processing portion 423 into the rectangle for the subsequent packet sending. In other words, the scan processing in the scanner portion 110 is performed in the raster order (line sequential) using an image sensor having a line shape. Therefore, the raster packet converting portion 422 converts the order of the pixels in the image data into the rectangle. In addition, in the present Embodiment, the RAM 270 is used as the temporary buffer for converting the image data from the raster order into the rectangle of 32 pixels×32 pixels, so that the raster packet converting portion 422 accesses the RAM 270 via the RAM controller 260.

The scan image processing portion 423 receives the image data from the scanner portion 110, and performs image processing such as the shading correction processing, the MTF correction processing, the input gamma correction, and the filter processing (i.e., generates the image data). In addition, the scan image processing portion 423 performs image area separation by performing edge detection and thickness determination, and generates the attribute data from the image data. The scan image processing portion 423 constitutes the generating portion which generates the image data and generates the attribute data indicating the attribute of the image data and indicating whether or not the image data includes at least a character. The image data and the attribute data are used in the printing function. In addition, by the compressor 421, the image data is compressed into JPEG and the attribute data is compressed into the packbits, and used for the analysis in the state of being compressed by the fixing temperature calculating portion 325, which will be described below. The compressor 421 constitutes the compression portion which compresses the image data and generates the compressed image data, and compresses the attribute data and generates the compressed attribute data. The image data after the image processing is output to the raster packet converting portion 422. In addition, the scan image processing portion 423 needs to receive the image data so as to catch up an input transfer speed of the input image data so as not to stop the scanning operation using the image sensor in the scanner portion 110. On the other hand, as for the packet sending by the packet input/output I/F 420, in a case in which timings of the packet sending of each image processing portion and the packet sending thereof overlap, the sending may be made to wait, so that a sending speed is not stable. Therefore, the scan image processing portion 423 temporarily writes the image data into the RAM 270, via the RAM controller 260, as an image buffer for temporary buffering until a sending timing for the image data which is received. Then, the scan image processing portion 423 reads the image data from the RAM 270 in synchronization with the timing of the packet sending, and sends the image data to the raster packet converting portion 422. <Attribute data>

Next, the attribute data in the present Embodiment will be described. Digital document data created by an application on the host computer (a client PC, etc.) 500 connected via the network 150 is, generally, expressed by a command system called PDL. Roughly divided, the PDL is composed of three objects. The first is a character object. The second is a graphic object such as vector data such as a figure and a free curve. The third is a natural image (bitmap) object such as the image data obtained by reading a photograph or printed product with the scanner, etc. In a case in which the object is the character, the object is composed of data such as a character code for identifying which character the character is, a font defining a shape of the character, size information representing a size of the character, and color information representing a color of the character, and is not information interpretable by the printer portion 140 as it is. Therefore, a printer driver on the host computer 500 serves as an interface with the printer portion 140. In other words, while playing a role for synchronizing so that an appropriate image can be output, the printer driver sends a command sequence representing the object such as the character, the graphic, and the natural image (bitmap) to the rendering portion 352. The rendering portion 352 converts the received command sequence into two-dimensional bitmap data, which the printer portion 140 can appropriately interpret, and outputs an attribute map. The attribute map is a map in which the attribute data for each pixel is provided to each pixel and is made into two-dimensional information.

Part (a) of FIG. 8 is an explanatory view illustrating an example of a format of the attribute data used in the present Embodiment. As shown in part (a) of FIG. 8, in the present Embodiment, the attribute data is constituted by 4-bit information. 0th bit of the attribute data is a Bitmap flag. If this flag is 1, it is indicated that the pixel is generated from the Bitmap object, and if the flag is 0, it is indicated that the pixel is generated from the Vector object.

1st bit of the attribute data is a Character flag. If this flag is 1, it is indicated that the pixel is a character, and if the flag is 0, it is indicated that the pixel is not a character.

2nd bit of the attribute data is an Object flag. If this flag is 1, it is indicated that the pixel is generated from an object, and if the flag is 0, it is indicated that the pixel is generated from other than the object.

3rd bit of the attribute data is a color flag. If this flag is 1, it is indicated that the pixel is a color pixel, and if the flag is 0, it is indicated that the pixel is a black and white pixel.

For example, if 4 bits of the attribute data are “0010 (=0(3rd bit) 0 (2nd bit) 1 (1st bit) 0 (0th bit))”, it indicates that it is a pixel of a background. Similarly, “0110” indicates a pixel of a character, “0100” indicates a pixel of a graphic, “0101” indicates a pixel of an image, and “0111” indicates a pixel of a line. These examples indicate that they are all black and white pixels since the uppermost 3rd bit thereof are 0.

Incidentally, the flags indicating the attributes shown here are merely examples, and it may be configured to be a simplified classification, in which a bit width is reduced and the pixel is classified into a character and other than a character, or a subdivided classification in which the bit width is expanded and the pixel is further finely classified into a fine line, a small character, etc.

In the present Embodiment, upon converting an object into two-dimensional bitmap data, the rendering portion 352 determines, for each pixel, from which object among the character, the graphic, and the natural image (bitmap, image) the bitmap data is finally generated. Then, the rendering portion 352 generates the attribute map so as to be corresponded to the two-dimensional image data.

Part (b) of FIG. 8 is an explanatory view illustrating an example of the attribute map in the present Embodiment. Part (b) of FIG. 8 shows an image in which a number “1”, which is the character object, is superimposed on the bitmap object.

Upon converting the object into the two-dimensional bitmap data, in accordance with the format of the attribute data in part (a) of FIG. 8, for each pixel, for example, in a case of a pixel of the character “0110”, the rendering portion 352 outputs 6 (decimal number corresponding to “0110”), and in a case of a pixel of the background “0010”, the rendering portion 352 outputs 2 (decimal number corresponding to “0010”), and generates the attribute map as shown in part (b) of FIG. 8.

The attribute map may be configured in any manner as long as it may be stored so that the attribute for each pixel can be corresponded to the two-dimensional image data. For example, by using the attribute map, the following become possible.

Part (c) of FIG. 8 is a schematic view illustrating an example of an image including image areas of different attributes. It will be described with reference to the example of the image shown in part (c) of FIG. 8 An image area 801 has a character (TEXT) image, an image area 802 has a graphic image such as a circle and a rectangle which is electronically generated, and an image area 803 has a natural image such as a photograph read by the scanner, and thus each has different attribute. Here, a case in which the printer portion 140 can reproduce only binary dots may also be considered. For example, in this case, the rendering portion 352 expands the object into multi-value bitmap data of Y, M, C, and K. Then, the print processing portion 230, which has received the bitmap data, performs known binarization processing such as the error diffusion method and the dither processing, and converts a multi-value image signal into a binary image signal. Thereafter, printing is performed. At this time, an optimal binarization method varies depending on the attribute of the image. That is, for the character and the graphic such a figure, binarization placing importance on resolution by reducing a matrix size of dither is preferable. In addition, for the natural image such as a photograph, it is preferable to place importance on gradation reproducibility by increasing the matrix size.

Therefore, by using the attribute map described above, as the character image in the image area 801 is “0110”, the graphic image in the image area 802 is “0100”, and the natural image (bitmap) in the image area 803 is “0111”, the attribute data for each image area can be known. Therefore, it becomes easier to perform the classification, for each pixel, of the natural image, the character image, and the graphic image, and it becomes possible to perform the image processing corresponding to characteristic for each pixel.

### <Packbits Compression>

Next, an algorithm for the packbits compression will be described. Incidentally, for the description herein, it will be described using the 4-bit attribute data described above.

The packbits compression is performed by dividing input data into a “same data sequence”, which is a portion in which the same data continues, and a “different data sequence”, which is a portion in which different data continues. Then, a “length”, which represents a length of each sequence, is attached to each sequence. Then, as for the “same data sequence”, run-length compression is performed, and the data portion is made into one data. For example, a case in which the input data is “0, 0, 0, 0, 1, 2, 3, 4, 4, 4, 4, 4, 4, 4, 4, 5, 5, 6, 7, 8, 8, 9, 10, 10” will be considered.

First, the data sequence is divided into the “same data sequence” and the “different data sequence” in a manner that “0, 0, 0, 0, 1, 2, 3, 4, 4, 4, 4, 4, 4, 4, 4, 5, 5, 6, 7, 8, 8, 9, 10, 10”.

Then, the “length” is added to each portion, and further the run-length compression is performed to the “same data sequence”, and it becomes as follows. “(−4), 0, (3), 1, 2, 3, (−8), 4, (−2), 5, (2), 6, 7, (−2), 8, (1), 9, (−2), 10”

Here, a value of the length is expressed with parentheses as “(−4)” in order to distinguish from the data. In addition, in a case in which the length is a negative value, it indicates that the sequence is the “same data sequence”, and in a case in which the length is 0 or a positive value, it indicates that the sequence is the “different data sequence”. In addition, the length is also converted into a “length code” having a width of 8 bits similarly to the data. Part (a) of FIG. 9 is an explanatory view showing a correspondence table between the length and the length code. According to the correspondence table in part (a) of FIG. 9, when the input data sequence of the above example is subjected to the packbits compression, the following output code is obtained.

“(0xfd), 0, (0x02), 1, 2, 3, (0xf 9), 4, (0xff), 5, (0x01), 6, 7, (0xff), 8, (0x00), 9, (0xFF), 10”

When the values of the data are also converted into hexadecimal notation, the output code becomes as follows.

### “FD 00 02 01 02 03 F9 04 FF 05 01 06 07 FF 08 00 09 FF 0A”

Incidentally, in the description in the present Embodiment, since the bit width of the “length code” is described as 8 bits including a positive/negative sign, a maximum value of the length becomes 128. In a case in which the length becomes 129 or more, the length of the “different data sequence” is divided into a sequence of which the length=128 and a sequence of which the length=(the length−128). Similarly, in a case in which the length≤−129, the length of the “same data sequence” is divided into a sequence of which the length=−128 and a sequence of which the length=(the length+128). However, in a case in which the length is −129 (in a case in which the same value continues for 129 sequence), it should be noted that the “same data sequence” is divided into the “same data sequence” of which the length=−128 and the “different data sequence” of which the length=1. Then, this “different data sequence” of which the length=1 becomes a combined sequence, if there is another following “different data sequence”. Needless to say, the configuration in which the bit width of the “length code” is set to 8 bits is an example, and the “length code” may be configured to have a larger bit width.

By taking a part of the image shown in part (c) of FIG. 8 as an example, the packbits compression will be further described using part (b) of FIG. 9. Part (b) of FIG. 9 is an explanatory view for describing an example of the packbits compression. In the present Embodiment, the image data is compressed by the 32×32 pixels per packet, however, here, for simplification of description, an example in which the attribute map of 8×8 pixels is compressed into the packbits will be described. The attribute map is composed of a portion of the character, a portion of the graphic, and a portion of the natural image (bitmap, image), and compressing data arranged from an upper left to the right of 8×8 pixels is performed until the lower right of 8×8 pixels.

First, with respect to the image shown in part (b) of FIG. 9, when the attribute data of three highlighted portions are described in an order from the upper left to the lower right, respectively, they become data sequences as follows. The data sequences are shown in an order of respective highlighted portions of the character, the graphic, and the natural image.

“22222222_66662222_66666222_22266222_22266222_22222222_22222222_222222 22”
“44444444_44444444_44444444_44444444_44444444_44444444_44444444_444444 44”
“77777222_77777222_77777222_77777222_77777222_22222222_22222222_222222 22”

When the data sequences are converted into the consecutive numbers and the data values, they become as follows.

“(−8)2, (−4)6, (−4)2, (−5)6, (−6)2, (−2)6, (−6)2, (−2)6, (−27)2”
“(−64)4”
“(−5)7, (−3)2, (−5)7, (−3)2, (−5)7, (−3)2, (−5)7, (−3)2, (−5)7, (−27)2”

When the “length” described above is converted into the “length code” according to the table shown in part (a) of FIG. 9, and the data sequence is converted into a code, it becomes as follows.

“0xF9, 0x02, 0xFD, 0x06, 0xFD, 0x02, 0xFC, 0x06, 0xFB, 0x02, 0xFF, 0x06, 0x, 0x02”
“0xC1, 0x04”
“0xFC, 0x07, 0xFE, 0x02, 0xFC, 0x07, 0xFE, 0x02, 0xFC, 0x07, 0xFE, 0x02, 0xFC, 0x07, 0xFE, 0x02, 0xFC, 0x07, 0xE6, 0x02”

The attribute data corresponding to the 8×8 pixels of the three highlighted portions in part (b) of FIG. 9 can be represented by the above codes, respectively. As it can be seen from the example described above, the more the same data continues, the less a size of the compressed code.

In this manner, by compressing the attribute data into the packbits, it becomes possible to reduce a data size upon storing the attribute data in the memory.

And, in the present Embodiment, by analyzing this compressed attribute data, compared with a case in which the uncompressed attribute data is analyzed, it becomes possible to reduce a processing load for the analysis. Incidentally, in the present Embodiment, the CPU 310 of the system control portion 210 performs the analysis, however, a dedicated circuit of hardware may be configured to perform similar analysis. Also in the case of performing with the hardware, it becomes possible to reduce the processing load by adopting the method in the present Embodiment.

Here, it is not limited to using the attribute data indicating all of the attributes described above as the attribute data, but it is sufficient that the characteristic of an image, for which it is desired to lower the fixing temperature from a normal fixing temperature for reduction of power consumption, for example, can be determined. Typically, as the attribute data, the data indicating the attribute of the image data and indicating whether or not the image data includes at least a character is used.

### <Fixing Temperature Control Based on the Analyzing Result of the Attribute Data>

Next, a fixing temperature control based on the analyzing result of the attribute data in the present Embodiment will be described. As an example, a method for controlling, depending on the characteristic of the image data, so as to lower to two kinds of the fixing temperatures lower than the normal fixing temperature will be described. In other words, it is configured that the fixing temperature is set to any one of a first fixing temperature, a second fixing temperature higher than the first fixing temperature, and a third fixing temperature higher than the second fixing temperature, and the third fixing temperature is the normal fixing temperature. Here, as an example, it is configured that in a case in which “data in a page is entirely composed of the background or the character (i.e., there is only the background or the character in the data in the page), and a character size is a predetermined size or less”, the fixing temperature is set to the first fixing temperature. In addition, here, as an example, it is configured that in a case in which “the data in the page is entirely composed of the background or the character” and “the character size is larger than the predetermined size”, the fixing temperature is set to the second fixing temperature. Further, here, determination of the fixing temperature based on a density of the image and consecutiveness of the image is also performed. Hereinafter, it will be described in detail.

### {Fixing Temperature Control}

Using FIG. 10, the control for the fixing temperature in the present Embodiment will be described. Part (a) of FIG. 10 is a flowchart diagram illustrating a process executed by control of the CPU 310 of the system control portion 210, and part (b) of FIG. 10 is a flowchart diagram illustrating a process executed by control of the CPU 391 of the printer control portion 280.

First, using part (a) of FIG. 10, the process executed by the control of the CPU 310 of the system control portion 210 will be described.

In S101, the CPU 310 receives a print job input from the external device such as the host computer 500 connected via the scanner portion 110 or the network 150, and starts the print process.

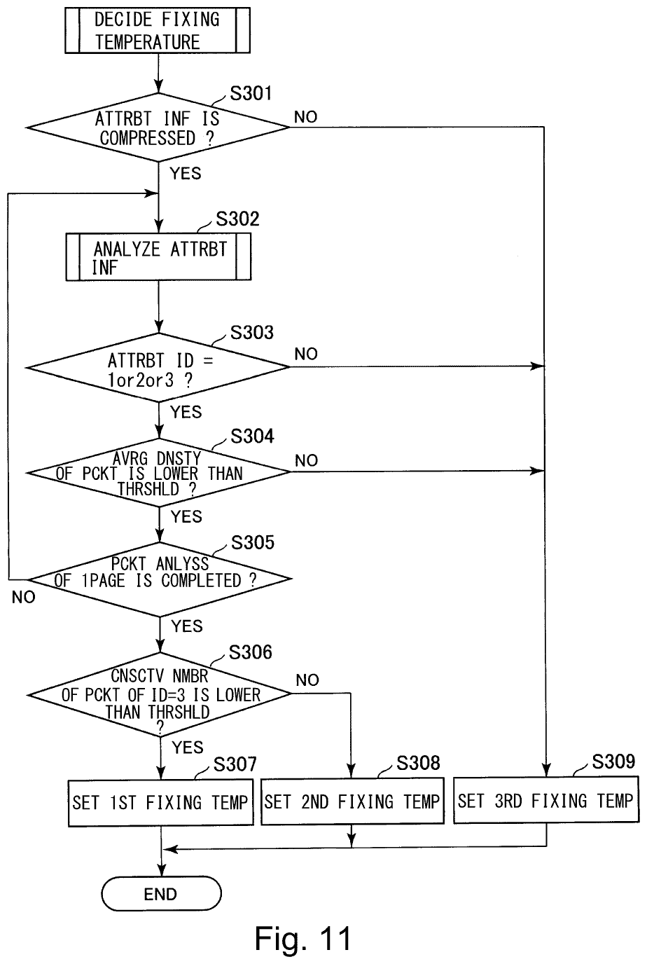

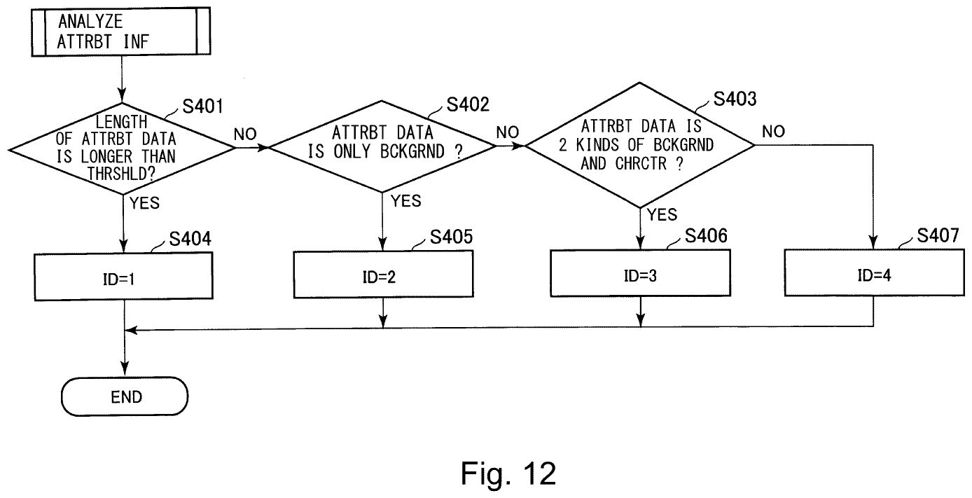

In S102, under an instruction of the CPU 310, the fixing temperature calculating portion 325 calculates a fixing target temperature upon printing a page to be printed included in the print job. Specific process performed by the fixing temperature calculating portion 325 in S102 will be described below using flowchart diagrams in FIG. 11 and FIG. 12.

In S103, the CPU 310 notifies the CPU 391 of the printer control portion 280 of the fixing target temperature information required for printing the page to be printed, which is determined in S102, through a printer communication I/F portion 303.

In S104, the CPU 310 determines whether or not there is a next page in the print job, and if there is the next page, then the CPU 310 repeats the process from S102.

Next, using part (b) of FIG. 10, the process executed by the control of the CPU 391 of the printer control portion 280 will be described.

In S201, the CPU 391 waits for a print instruction from the CPU 310 of the system control portion 210. If the CPU 391 receives the print instruction from the CPU 310 of the system control portion 210, then the CPU 391 proceeds the process to S202.

In S202, the CPU 391 confirms whether or not the fixing target temperature information required for fixing the page to be printed, which is received from the CPU 310 of the system control portion 210, is received. If the CPU 391 receives the fixing target temperature information required for fixing the page to be printed from the CPU 310 of the system control portion 210 through the system communication I/F portion 396 in S202, then the CPU 391 proceeds the process to S203. Normally, the fixing target temperature information required for fixing the page is received several pages before printing the page, however, if the information is not received, after a lapse of a predetermined time for waiting for the receiving, the process in S202 is executed again. Incidentally, in the case in which the fixing target temperature information is not received, it may be configured to control so as to proceed the process to S203 in order to prioritize the printing, and set the fixing temperature corresponding to the maximum toner application amount (normal fixing temperature) without lowering the fixing target temperature.

In S203, under an instruction of the CPU 391, the fixing temperature control portion 319 controls the fixing device 30 so that the fixing temperature becomes the fixing target temperature received in S202. Specifically, if it is necessary to cause the fixing temperature to be reached to the fixing target temperature, the fixing temperature control portion 319 controls power supply to the heaters 34 and 35 so as to raise the fixing temperature. In addition, with respect to the fixing target temperature, if it is possible to lower the fixing temperature, control for lowering the fixing temperature is performed as necessary. Examples of the control for lowering the fixing temperature include control for waiting until the temperature drops, and control for performing intake or exhaust by a fan.

In S204, the CPU 391 determines whether or not it is an end of the print job (whether or not there is a next page in the print job), and if the print job is not ended, repeats the process from S202.

### {Determination of the Fixing Temperature}

Using FIG. 11 and FIG. 12, determination of the fixing temperature using the analyzing result of the compressed attribute data in the present Embodiment will be described. FIG. 11 is the flowchart diagram illustrating a process executed in S102 in FIG. 10. In addition, FIG. 12 is the flowchart diagram illustrating a process executed in S302 in FIG. 11.

First, using FIG. 11, the determination of the fixing temperature will be described. A flow shown in FIG. 11 is a flow of a process for the determination of the fixing temperature executed by the control of the CPU 310 of the system control portion 210 in S102 in FIG. 10.

In S301, the CPU 310 determines whether or not the attribute information included in the packet data of the page to be printed is compressed. This determination is performed by the CPU 310 referring to the attribute compression flag 611, which is one of the information in the header portion 650 of the packet of the page to be printed. If the attribute information is compressed data, then the CPU 310 proceeds the process to S302. On the other hand, if it is data which is not compressed, then the CPU 310 proceeds the process to S309. Incidentally, in the present Embodiment, it is configured that as a result of the determination in S301, if it is the data which is not compressed, the analysis is not performed. However, although the processing load becomes heavy, it may be configured to proceed the process to S302 to analyze the uncompressed attribute data.

In S302, under an instruction of the CPU 310, the fixing temperature calculating portion 325 analyzes the compressed attribute information included in the packet data to be printed, and assigns an attribute ID to the packet based on an analyzing result. This attribute ID indicates what kind of the characteristic of the image is included in the packet. The CPU 310 causes the attribute ID assigned to each packet to be stored in the RAM 331.

Here, using FIG. 12, the process in S302 in FIG. 11 will be described first. A flow shown in FIG. 12 is a flow, in S302 in FIG. 11, of an attribute information analyzing process executed by the fixing temperature calculating portion 325 under an instruction of the CPU 310 of the system control portion 210.

In S401, the fixing temperature calculating portion 325 determines whether or not the attribute byte length 609 of the packet is equal to or larger than a predetermined threshold value. If the attribute byte length 609 is equal to or larger than the threshold value, then the fixing temperature calculating portion 325 proceeds the process to S404, and if the length is smaller (shorter) than the threshold value, then the fixing temperature calculating portion 325 proceeds the process to S402. As per the specification of the packbits described above, in a case in which data having different attributes exist in an inconsecutive manner in the packet, the attribute byte length becomes large. For example, in a case in which the attributes are different for each pixel, a plurality of data, in which a sequence thereof is the “different data sequence” and 128 pieces of the attribute data continue, exist. This becomes substantially equivalent to analyzing the uncompressed data. By checking the attribute byte length through the process in S401, it becomes possible to reduce the processing load for the CPU 310.

In S402, the fixing temperature calculating portion 325 determines whether or not the attribute data of the attribute portion 630 is only an attribute indicating the background. For example, in the case of the packbits compression type described above, if data for the length following the sequence are all the backgrounds, then the fixing temperature calculating portion 325 proceeds the process to analysis of a next sequence. And the fixing temperature calculating portion 325 proceeds the process to S403 at a time when an attribute other than the background appears. If the attribute data is only the background after examining to an end thereof, then the fixing temperature calculating portion 325 proceeds the process to S405.

In S403, the fixing temperature calculating portion 325 determines whether or not the attribute data of the attribute portion 630 includes only two kinds of the attribute indicating the background and the attribute indicating the character. If the attribute data is only the two kinds of the background and the character, then the fixing temperature calculating portion 325 proceeds the process to S406. On the other hand, if an attribute data other than the background and the character is included in the attribute data, then the fixing temperature calculating portion 325 proceeds the process to S407. Incidentally, in the present example, also in a case in which the attribute datais only the attribute indicating the character, the process is proceeded to S407. In this manner, if the attribute data of the attribute portion 630 includes only the attribute of the background, the process is proceeded to S405. In addition, if the attribute data includes the two kinds of attributes of the background and the character, the process is proceeded to S406. Further, if the attribute data includes only the attribute of the character, or if the attribute data includes the attribute other than the two kinds of attributes of the background and the character, the process is proceeded to S407.

In S404, the fixing temperature calculating portion 325 sets the attribute ID in the packet to 1. Data, of which the attribute ID in the packet is 1, is data, of which the attribute data length is equal to or larger than the predetermined threshold value. Since the longer the attribute data length is, the lower a compression rate and consecutiveness of areas of the same attribute, it is indicated that areas of which the attributes, which are two or more kinds, are different are scattered. In other words, it is indicated that an area of a large size character or an image, in which a toner density is likely to be high, does not exist. Therefore, the packet, of which the attribute ID is 1, is an area in which the fixing of the toner image is possible even when the fixing temperature lower than the fixing temperature corresponding to the maximum toner application amount which can be assumed (normal fixing temperature) is set. As the threshold value for the attribute data length, for example, a maximum value of the attribute data length, with which fixing defect may occur in a case of not being the fixing temperature corresponding to the maximum toner application amount, may be set.

In S405, the fixing temperature calculating portion 325 sets the attribute ID in the packet to 2. The packet, of which the attribute ID is 2, indicates that it is a packet of an area including only the background. In other words, an area of a graphic, in which the toner density is likely to be high, does not exist. Therefore, the packet, of which the attribute ID is 2, is an area in which the fixing of the toner image is possible even when the fixing temperature lower than the fixing temperature corresponding to the maximum toner application amount which can be assumed (normal fixing temperature) is set.

In S406, the fixing temperature calculating portion 325 sets the attribute ID in the packet to 3. The packet, of which the attribute ID is 3, indicates that it is a packet of an area in which the background and the character are mixed. In other words, it is indicated that an area of a graphic, in which the toner density is likely to be high, does not exist. Therefore, it is possible to determine that the packet, of which the attribute ID is 3, is an area in which the fixing of the toner image is possible even when the fixing temperature lower than the fixing temperature corresponding to the maximum toner application amount which can be assumed (normal fixing temperature) is set.

In S407, the fixing temperature calculating portion 325 sets the attribute ID in the packet to 4. The packet, of which the attribute ID is 4, is an area of only the character or an area in which an object other than the character and the background exists. In other words, it is indicated that there is a possibility that an area, in which the toner density is likely to be high, such as a large size character and a graphic exists. Therefore, the packet, of which the attribute ID is 4, is an area for which the fixing temperature corresponding to the maximum toner application amount which can be assumed (normal fixing temperature) should be set.

By performing the process of S401 through S407 described above for all packets, of the analyzing conditions that “the data in a page is entirely composed of the background or the character, and the character size thereof is the predetermined size or less”, it becomes possible to determine whether or not “the data in the page is entirely composed of the background or the character”.

Incidentally, in the present example, for the packet in which the attribute data of the attribute portion 630 is only the character, the attribute ID is set to 4, however, it may be configured as follows. That is, in S306, which will be described below, based on information of a position of the packet in the page and the consecutiveness, by determining whether or not the packet of only the character exists in isolation, it becomes possible to detect the large size character. In this case, in S403, 3 may be assigned as the attribute ID to the packet, of which the attribute data is only the character. And it may be configured that if the large size character is detected in S306, which will be described below, then the normal fixing temperature is set.

Returning to the description of the flow for the determination of the fixing temperature in FIG. 11.

In S303, if the attribute ID assigned by the attribute information analysis in S302 is 1, 2, or 3, then the CPU 310 proceeds the process to S304. On the other hand, if the attribute ID is other than those (i.e., the attribute ID is 4), then the CPU 310 proceeds the process to S309. Through this process, in a case of the attribute other than the background and the character, by determining not to lower the fixing temperature (fixing target temperature, setting temperature for fixing temperature adjustment) from the normal fixing temperature and not performing the analysis for a rest of the packet, it becomes possible to reduce the processing load for the CPU 310.

In S304, the CPU 310 determines, based on the Thumbnaildata 612, whether or not an average density is equal to or lower than a predetermined threshold value. The higher the average density is, the higher the density of the toner becomes. Therefore, in a case in which the average density is higher than the threshold value, irrespective of the value of the attribute ID, it is necessary to set to the fixing temperature corresponding to the maximum toner application amount which can be assumed (normal fixing temperature).

As the threshold value for this average density, for example, a minimum value of the average density, with which the fixing defect may occur in a case of not being the fixing temperature corresponding to the maximum toner application amount, may be set. If the average density is lower than the threshold value, then the CPU 310 proceeds the process to S305. On the other hand, if the average density is equal to or higher than the threshold value, then the CPU 310 proceeds the process to S309. Through this process, in a case in which there is a packet in which the density is high, by determining not to lower the fixing temperature (fixing target temperature, setting temperature for fixing temperature adjustment) from the normal fixing temperature and not performing the analysis for the rest of the packet, it becomes possible to reduce the processing load for the CPU 310. In other words, by performing the determination for the density described above for all packets for one page, it becomes possible for the CPU 310 (fixing temperature calculating portion 325) to acquire the information of the average density of the image in the whole area of the image formable area for the one page. And in a case in which the average density is higher than the predetermined threshold value, it becomes possible for the CPU 310 (fixing temperature calculating portion 325) to determine, irrespective of the compressed attribute data, not to lower the fixing temperature from the normal fixing temperature.

In S305, the CPU 310 determines whether or not the analysis for all packets for one page is completed, and if it is completed then the CPU 310 proceeds the process to S306, and if it is not completed then the CPU 310 repeats the process from S302.

In S306, the CPU 310 determines whether or not the consecutiveness in the main scanning direction (direction substantially perpendicular to a conveyance direction of the recording material) and the consecutiveness in the sub scanning direction (conveyance direction of the recording material) of the packet, of which the attribute ID assigned through the attribute information analysis in S302 is 3, are equal to or less than a predetermined threshold value. The larger the consecutiveness of the packet of which the attribute ID is 3, i.e., the consecutiveness of the packet including the background and the character is, the more likely it is that a large size character area exists. In the large size character, the toner density is high. Therefore, it is desired that if at least one of the consecutiveness in the main scanning direction or the consecutiveness in the sub scanning direction is higher than the threshold value, the fixing temperature corresponding to the maximum toner application amount which can be assumed (normal fixing temperature, third fixing temperature) or the fixing temperature relatively close thereto (second fixing temperature) be set. The threshold value for the consecutiveness in the main scanning direction and the threshold value for the consecutiveness in the sub scanning direction may be appropriately set in view of fixing performance, etc. For example, assuming that for a character having the character size of 12 pt or more, there is a possibility that the fixing defect occurs when it is not the fixing temperature corresponding to the maximum toner application amount (normal fixing temperature, third fixing temperature) or the fixing temperature relatively close thereto (second fixing temperature). In this case, a consecutive number of the packets corresponding to the size of 12 pt may be set as the threshold value for the consecutiveness in the main scanning direction and the threshold value for the consecutiveness in the sub scanning direction. The threshold value for the consecutiveness in the main scanning direction and the threshold value for the consecutiveness in the sub scanning direction may be the same value or different values. If the consecutiveness in both the main scanning direction and the sub scanning direction is equal to or less than the threshold value, the CPU 310 proceeds the process to S307. On the other hand, if the consecutiveness in at least one of the main scanning direction or the sub scanning direction is larger than the threshold value, the CPU 310 proceeds the process to S308.

Here, in the present Embodiment, one packet is composed of 32×32 pixels. In a case of the resolution being 600 dpi, one pixel corresponds to 43 μm, so that in a case in which one packet is entirely the character, a vertical and horizontal sizes of the packet become a size of about 1.3 mm×1.3 mm or more. Therefore, based on the consecutive number in the main scanning direction or the sub scanning direction, the character size can be specified. Therefore, of the analyzing conditions that “the data in the page is entirely composed of the background or the character, and the character size thereof is the predetermined size or less”, it becomes possible to determine whether or not “the character size thereof is the predetermined size or less”.

Incidentally, it may be configured that if the consecutiveness is larger than the threshold value in S306, the process is proceeded to S309. In other words, it may be configured that the setting for the fixing temperature is the two kinds corresponding to the first fixing temperature and the third fixing temperature in the present Embodiment.

In S307, the CPU 310 sets the fixing target temperature to the first fixing temperature. The first fixing temperature is a temperature lower than the second fixing temperature. The first fixing temperature may be appropriately set in view of the fixing performance, etc. For example, as the first fixing temperature, a fixing temperature lower by 9° C. than the fixing temperature corresponding to the maximum toner application amount which can be assumed (normal fixing temperature, third fixing temperature) may be set.

In S308, the CPU 310 sets the fixing target temperature to the second fixing temperature. The second fixing temperature is a temperature lower than the third fixing temperature and higher than the first fixing temperature. The second fixing temperature may be appropriately set in view of the fixing performance, etc. For example, as the second fixing temperature, a fixing temperature lower by 5° C. than the fixing temperature corresponding to the maximum toner application amount which can be assumed (normal fixing temperature, third fixing temperature) may be set.

In S309, the CPU 310 sets the fixing target temperature to the third fixing temperature. The third fixing temperature is a temperature higher than the second fixing temperature. The third fixing temperature may be appropriately set in view of the fixing performance, etc. For example, as the third fixing temperature, a fixing temperature corresponding to the maximum toner application amount which can be assumed (normal fixing temperature) may be set. In this manner, typically, the third fixing temperature (third temperature) is a fixing target temperature in the case in which the whole area of the image formable area for the one page is the image of the maximum toner application amount for the image forming apparatus 100 (image forming portion 160). And the second fixing temperature (second temperature) is a temperature lower than the third fixing temperature, and the first fixing temperature (first temperature) is a temperature lower than the second fixing temperature.

In this manner, in the present Embodiment, the image forming apparatus 100 includes the image forming portion 160 which forms the image on the recording material 11 with the toner based on the image data, the fixing portion 30 which fixes the image onto the recording material 11 by applying heat to the recording material 11 on which the image is formed by the image forming portion 160, the generating portion (rendering portion) 352 which generates the image data and generates the attribute data indicating the attribute of the image data and indicating whether or not the image data includes at least the character, the compressing portion (image compressing portion) 350 which compresses the image data and generates the compressed image data, and compresses the attribute data and generates the compressed attribute data, the setting portion (fixing temperature calculating portion) 325 which analyzes the compressed image data or the compressed attribute data corresponding to the image for the one page, which is to be formed on one sheet of the recording material 11, in the state of being compressed, and sets the target temperature of the fixing portion 30 at the time when the image for the one page is fixed to the recording material 11 based on the analyzing result, and the control portion (fixing temperature control portion) 319 which controls the fixing portion 30 based on the target temperature set by the setting portion 325.

In the present Embodiment, in the case in which the analyzing result indicates that the image data of the image for the one page is composed of the image data of the two kinds of attributes of the background and the character, the setting portion 325 sets the target temperature to the first temperature lower than the temperature in the case in which the whole area of the image formable area for the one page is the image of the maximum toner application amount. In addition, in the present Embodiment, in the case in which the analyzing result indicates that the attributes of the image data of the image for the one page are all backgrounds, the setting portion 325 sets the target temperature to the first temperature lower than the temperature in the case in which the whole area of the image formable area for the one page is the image of the maximum toner application amount. In addition, in the present Embodiment, in the case in which the analyzing result indicates that the size of the compressed image data or the compressed attribute data corresponding to the image for the one page is equal to or more than the predetermined threshold value, the setting portion 325 sets the target temperature to the first temperature lower than the temperature in the case in which the whole area of the image formable area for the one page is the image of the maximum toner application amount. In addition, in the present Embodiment, in the case in which the analyzing result indicates that the image data of the image for the one page is composed of the image data of the two kinds of the attributes of the background and the character, when in the image for the one page the consecutive number of the image data of which the attributes of the background or the character in the conveyance direction of the recording material 11 is equal to or less than the predetermined threshold value, the setting portion 325 sets the target temperature to the first temperature lower than the temperature in the case in which the whole area of the image formable area for the one page is the image of the maximum toner application amount, and when the consecutive number is larger than the predetermined threshold value, the setting portion sets the target temperature to the second temperature higher than the first temperature and lower than the temperature in the case in which the whole area of the image formable area for the one page is the image of the maximum toner application amount. In addition, in the present Embodiment, in the case in which the analyzing result indicates that the image data of the image for the one page is composed of the image data of the two kinds of the attributes of the background and the character, when in the image for the one page the consecutive number of the image data of which the attributes of the background or the character in the direction substantially perpendicular to the conveyance direction of the recording material 11 is equal to or less than the predetermined threshold value, the setting portion 325 sets the target temperature to the first temperature lower than the temperature in the case in which the whole area of the image formable area for the one page is the image of the maximum toner application amount, and when the consecutive number is larger than the predetermined threshold value, the setting portion sets the target temperature to the second temperature higher than the first temperature and lower than the temperature in the case in which the whole area of the image formable area for the one page is the image of the maximum toner application amount.

In addition, in the present Embodiment, in the case in which the analyzing result indicates that the attributes of the image data of the image for the one page are all characters, or the image data of the image for the one page includes the image data of the attribute other than the two kinds of the attributes of the background and the character, the setting portion 325 sets the target temperature to the third temperature higher than the first temperature. In addition, in the present Embodiment, in the case in which the analyzing result indicates that the attributes of the image data of the image for the one page are all characters, or the image data of the image for the one page includes the image data of the attribute other than the two kinds of the attributes of the background and the character, the setting portion 325 sets the target temperature to the third temperature higher than the second temperature. In addition, in the present Embodiment, in the case in which the average density of the image, in the whole area of the image formable area for the one page, acquired without expanding the compressed image data and the compressed attribute data is higher than the predetermined threshold value, the setting portion 325 sets the target temperature to the third temperature higher than the first temperature irrespective of the compressed image data and the compressed attribute data. Incidentally, the third temperature is, for example, the temperature in the case in which the whole area of the image formable area for the one page is the image of the maximum toner application amount. In addition, the third temperature is, for example, the temperature higher than the second temperature. In addition, in the present Embodiment, the generating portion 352 generates the image data and the attribute data for each of the areas obtained by dividing the image for the one page into plural areas and generates the plurality of packets including the image data and the attribute data for each of areas which are divided, the compressing portion 350 compresses the image data and the attribute data for each of the packets, and the control portion 319 analyzes the compressed image data and the compressed attribute data for each of the packets in the state of being compressed and acquires the analyzing result regarding the image for the one page. In addition, in the present Embodiment, the control portion 319 analyzes the compressed attribute data in the state of being compressed and acquires the analyzing result.

As described above, in the present Embodiment, by analyzing the compressed attribute data in the state of being compressed, while reducing the processing load for the image analysis, it becomes possible to determine the fixing temperature. Here, the attribute data is data, which is generated in advance to be used for the image processing, for determining the background, the character, the photograph, etc. Therefore, according to the present Embodiment, in the configuration in which the control for the fixing temperature is performed depending on the image to be printed, while reducing the processing load for the image analysis, it becomes possible to determine the fixing temperature. By this, by controlling the fixing temperature depending on the image characteristic, it becomes possible to reduce power consumption.

Incidentally, in the present Embodiment, the setting temperature for the fixing temperature adjustment (fixing target temperature) is configured to be three kinds, however, it is not limited thereto. Although the processing load becomes heavier than in the case of the three kinds, it may be configured that by performing the analysis in more detail, the setting temperature for the fixing temperature adjustment is more finely divided into four or more kinds, so that power saving effect is further increased. Not limited to this, however, kinds of the setting temperatures for the fixing temperature adjustment may be appropriately selected from, for example, two or more kinds and ten or less kinds. Conversely, it may be configured to roughen the analysis to lighten the processing load. For example, the process in S306 may be omitted, and the setting of the fixing target temperature may be configured to be two kinds corresponding to the second fixing temperature and the third fixing temperature in the present Embodiment. In addition, the process in S304 may be omitted, and the fixing temperature may be set depending on whether the image for the one page is only the image of two kinds of the attributes of the background and the character (or is only the background) or includes the image of the attribute other than the background and the character (photograph, graphic). In this case, for example, it may be configured that the fixing temperature lower than the normal fixing temperature is set for the former image, and the normal fixing temperature is set for the latter. In addition, in this case as well, through a process similar to S306, by determining the size of the character, the fixing temperature may be changed depending on the size of the character similarly to the present Embodiment.

In addition, in the present Embodiment, it is described as the compression type for the attribute data is the packbits type, however, other compression types may be used.

Further, in the present Embodiment, the fixing temperature control is performed by analyzing the compressed attribute data, however, the compressed image data may be analyzed. For example, in a case in which based on the compressed code of the compressed image data, it may be determined that there are only black pixels corresponding to the character and pixels of a predetermined color corresponding to the background in a page (further, the size of the character is equal to or less than the predetermined size), it may be configured to control so as to lower the fixing temperature than the normal fixing temperature. In this case, an effect similar to that of the Embodiment described above can be obtained.

### [Others]

As described above, the present invention is described according to the specific Embodiment, however, the present invention is not limited to the above Embodiment.

In the Embodiment described above, for each of areas obtained by dividing the image for the one page evenly in the main scanning direction and the sub scanning direction into a plural areas for each predetermined number of pixels, the image data and the attribute data are generated. However, the image for the one page may be divided unevenly in at least one of the main scanning direction or the sub scanning direction.

In addition, it may also be contemplated that the image data and the attribute data are compressed without dividing the image for the one page, the compressed image data or the compressed attribute data is analyzed, and the fixing temperature is set and controlled based on an analyzing result.

In addition, in the Embodiment described above, by the system control portion, the analysis of the attribute is performed, the fixing target temperature is set based on the analyzing result, and by the printer control portion, the fixing portion is controlled so as to be the set fixing target temperature. However, the system configuration is not limited thereto, but is arbitrary as long as a result similar to that of the process described in the Embodiment described above is obtained. For example, it may be configured that by the system control portion, the analysis of the attribute is performed, and by the printer control portion, the fixing target temperature is set based on the analyzing result, and the fixing portion is controlled so as to be the set fixing target temperature.

In the Embodiment described above, the image forming apparatus is the color image forming apparatus, however, the present invention may also be applied to a monochrome (for example, single color of black) image forming apparatus.

In addition, the present invention may be regarded as an image forming apparatus which executes the processes described in the Embodiment described above, or may be regarded as an image forming method using the image forming apparatus or a control method for the image forming apparatus.

In addition, the present invention may also be realized by a process in which a program realizing one or more functions of the Embodiment described above is supplied to the system or the apparatus via the network or the storage medium, and one or more processors in a computer of the system or the apparatus read out and execute the program. In addition, the present invention can also be realized by a circuit (e.g., ASIC) which realizes the one or more functions.

In addition, by a method in which a computer executes a program, each process in the Embodiment described above may be realized. The program described above may be provided to the computer via, for example, the network or from a computer-readable recording medium, which stores data in a non-transitory manner, etc. The program described above may be stored in a computer-readable recording medium, etc.

According to the present invention, in the configuration in which the control for the fixing temperature is performed depending on the image to be printed, while reducing the processing load for the image analysis, it becomes possible to determine the fixing temperature.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2025-026297, filed Feb. 20, 2025, which is hereby incorporated by reference herein in its entirety.

What is claimed is:

1. An image forming apparatus comprising:
an image forming portion configured to form an image on a recording material with toner based on an image data;
a fixing portion configured to fix the image onto the recording material by applying heat to the recording material on which the image is formed by the image forming portion;
a generating portion configured to generate the image data and generate an attribute data indicating an attribute of the image data and indicating whether or not the image data includes at least a character;
a compressing portion configured to compress the image data and generate a compressed image data, and configured to compress the attribute data and generate a compressed attribute data;
a setting portion configured to analyze the compressed attribute data corresponding to the image for one page, which is to be formed on one sheet of the recording material, in a state of being compressed, and configured to set a target temperature of the fixing portion at a time when the image for the one page is fixed onto the recording material based on an analyzing result; and
a controller configured to control the fixing portion based on the target temperature set by the setting portion.

2. The image forming apparatus according to claim 1, wherein in a case in which the analyzing result indicates that the image data of the image for the one page is composed of the image data of two kinds of attributes of a background and the character, the setting portion sets the target temperature to a first temperature lower than a temperature in a case in which a whole area of an image formable area for the one page is an image of a maximum toner application amount.

3. The image forming apparatus according to claim 1, wherein in a case in which the analyzing result indicates that the attributes of the image data of the image for the one page are all backgrounds, the setting portion sets the target temperature to a first temperature lower than a temperature in a case in which a whole area of an image formable area for the one page is an image of a maximum toner application amount.

4. The image forming apparatus according to claim 1, wherein in a case in which the analyzing result indicates that a size of the compressed image data or the compressed attribute data corresponding to the image for the one page is equal to or more than a predetermined threshold value, the setting portion sets the target temperature to a first temperature lower than a temperature in a case in which a whole area of an image formable area for the one page is an image of a maximum toner application amount.

5. The image forming apparatus according to claim 1, wherein in a case in which the analyzing result indicates that the image data of the image for the one page is composed of the image data of two kinds of attributes of a background and the character, when in the image for the one page a consecutive number of the image data of which attributes of the background or the character in a conveyance direction of the recording material is equal to or less than a predetermined threshold value, the setting portion sets the target temperature to a first temperature lower than a temperature in a case in which a whole area of an image formable area for the one page is an image of a maximum toner application amount, and when the consecutive number is larger than the predetermined value, the setting portion sets the target temperature to a second temperature higher than the first temperature and lower than the temperature in the case in which the whole area of the image formable area for the one page is the image of the maximum toner application amount.

6. The image forming apparatus according to claim 1, wherein in a case in which the analyzing result indicates that the image data of the image for the one page is composed of the image data of two kinds of attributes of a background and the character, when in the image for the one page a consecutive number of the image data of which attributes of the background or the character in a direction substantially perpendicular to a conveyance direction of the recording material is equal to or less than a predetermined threshold value, the setting portion sets the target temperature to a first temperature lower than a temperature in a case in which a whole area of an image formable area for the one page is an image of a maximum toner application amount, and when the consecutive number is larger than the predetermined value, the setting portion sets the target temperature to a second temperature higher than the first temperature and lower than the temperature in the case in which the whole area of the image formable area for the one page is the image of the maximum toner application amount.

7. The image forming apparatus according to claim 2, wherein in a case in which the analyzing result indicates that the attributes of the image data of the image for the one page are all characters, or the image data of the image for the one page includes an image data of an attribute other than the two kinds of attributes of a background and the character, the setting portion sets the target temperature to a third temperature higher than the first temperature.

8. The image forming apparatus according to claim 7, wherein the third temperature is a temperature in the case in which the whole area of the image formable area for the one page is the image of the maximum toner application amount.

9. The image forming apparatus according to claim 5, wherein in a case in which the analyzing result indicates that the attributes of the image data of the image for the one page are all characters, or the image data of the image for the one page includes an image data of an attribute other than the two kinds of attributes of a background and the character, the setting portion sets the target temperature to a third temperature higher than the second temperature.

10. The image forming apparatus according to claim 9, wherein the third temperature is a temperature in the case in which the whole area of the image formable area for the one page is the image of the maximum toner application amount.

11. The image forming apparatus according to claim 2, wherein in a case in which an average density of an image, in the whole area of the image formable area for the one page, acquired without expanding the compressed image data and the compressed attribute data is higher than a predetermined threshold value, the setting portion sets the target temperature to a third temperature higher than the first temperature irrespective of the compressed image data and the compressed attribute data.

12. The image forming apparatus according to claim 11, wherein the third temperature is a temperature in the case in which the whole area of the image formable area for the one page is the image of the maximum toner application amount.

13. The image forming apparatus according to claim 5, wherein in a case in which an average density of an image, in the whole area of the image formable area for the one page, acquired without expanding the compressed image data and the compressed attribute data is higher than a predetermined threshold value, the setting portion sets the target temperature to a third temperature higher than the second temperature irrespective of the compressed image data and the compressed attribute data.

14. The image forming apparatus according to claim 13, wherein the third temperature is a temperature in the case in which the whole area of the image formable area for the one page is the image of the maximum toner application amount.

15. The image forming apparatus according to claim 1, wherein the generating portion generates the image data and the attribute data for each of areas obtained by dividing the image for the one page into plural areas and generates a plurality of packets including the image data and the attribute data for each of areas which are divided,
wherein the compressing portion compresses the image data and the attribute data for each of the packets, and
wherein the controller analyzes the compressed image data and the compressed attribute data for each of the packets in a state of being compressed and acquires the analyzing result regarding the image for the one page.

16. The image forming apparatus according to claim 1, wherein the controller analyzes the compressed attribute data in a state of being compressed and acquires the analyzing result.
